(19) United States
(12) Patent Application Publication
(10) Pub. No.: US 2016/0132644 A1
(43) Pub. Date: May 12, 2016

(54) Health Care Information Process System

(71) Applicant: HITACHI, LTD., Tokyo (JP)

(72) Inventors: Kunihiko KIDO, Tokyo (JP); Shuntaro YUI, Tokyo (JP); Kumiko SETO, Tokyo (JP)

(21) Appl. No.: 14/891,734

(22) PCT Filed: May 20, 2013
(86) PCT No.: PCT/JP2013/063886

§ 371 Date: Nov. 17, 2015

(51) Int. Cl. G06F 19/00; G06F 17/24; G06Q 30/04

(52) U.S. Cl. CPC G06F 19/322; G06Q 30/04; G06F 17/243

(57) ABSTRACT

High-quality health care information/medical data is provided. A system accumulating health care information comprises a receiving part that receives the health care information from a computer of a data provider; a memory part that stores therein criteria relating to health care and medical treatment with which the health care information is evaluated; n evaluation part that evaluates a value of the health care information based on the received health care information and the criteria; and a billing part that determines a fee for accumulating the health care information based on the value, the above-mentioned object is achieved.

### BACKGROUND

The present invention relates to a system configured to process health care information, and in particular, a system configured to accumulate health care information. Background arts of the technical field of the present invention include JP2006-059063 A. That document describes an evaluation of the quality of a radiologic interpretation report for respective test items used by a diagnostician who makes the final diagnosis by objectively evaluating findings of a radiologist who created the report as well as the consistency with the test request. In this document, the quality of report is evaluated from a perspective of how effectively the requests from the diagnostician are addressed. On the other hand, JP2006-113824 A describes a method for charging storage fees in which the charge amount is calculated based on the data access speed.

### SUMMARY

There are a great variety of clinical data, and it is often impossible to record all of the detailed information within a limited consultation time. For example, electronic medical records are the system to record clinical data, but the data recorded here is merely data required to conduct daily work such as order information for laboratory tests or prescription and medical care billing information, and the improvement of data quality (improvement of the quality of data that meets certain criteria) for the secondary usage of the data such as clinical researches is not considered a priority. Therefore, even if electronic storage of clinical data such as EHR (Electronic Health Record) is developed, which allows for sharing of data between a plurality of medical care providers, there is a limitation on the usage of the data such as analyzing the data to find a diagnosis and treatment guideline having a higher cost benefit.

An object of the present invention is to provide a system that efficiently accumulates high-quality health care information/medical data.

By a system accumulating health care information comprises a receiving part that receives the health care information from a computer of a data provider; a memory part that stores therein criteria relating to health care and medical treatment with which the health care information is evaluated; n evaluation part that evaluates a value of the health care information based on the received health care information and the criteria; and a billing part that determines a fee for accumulating the health care information based on the value, the above-mentioned object is achieved. With this system, when the health care information of a data provider is accumulated, an amount to be charged to the data provider for accumulating the health care information can be determined based on medical or health care criteria. As a result, depending on whether the accumulated health care information matches the medical criteria or not, an amount to be charged for storing the health care information can be changed. This promotes an input of high-quality health care information (that can be used secondarily) that meets the medical criteria, and it is possible to accumulate high-quality medical data efficiently.

### BRIEF DESCRIPTIONS OF DRAWINGS

FIG. 1 is a configuration diagram of the system according to Embodiment 1 and Embodiment 2.

FIG. 2 is a flow chart showing Embodiment 1.

FIG. 3 is an example of a target episode table.

FIG. 4 is an example of a patient table.

FIG. 5 is an example of an episode table.

FIG. 6 is an example of a medical practice table.

FIG. 7 is an example of a test result table.

FIG. 8 is an example of a prescription table.

FIG. 9 is an example of a relational table.

FIG. 10 is an example of data structure for diagnosis medical knowledge.

FIG. 11 is an example of a test-disease relevance table.

FIG. 12 is an example of a drug-disease relevance table.

FIG. 13 is a flow chart showing Embodiment 1.

FIG. 14 is a flow chart showing Embodiment 1.

FIG. 15 is an example of a medical institution table.

FIG. 16 is an example of data structure for a findings file.

FIG. 17 is an example of a findings table for quality evaluation.

FIG. 18 is a flow chart showing Embodiment 1.

FIG. 19 is an example of a billing information table,

FIG. 20 is an example of a data purchased amount table.

FIG. 21 is a graph showing relationship between data purchased amount and lower limit value of discount rate.

FIG. 22 is a flow chart relating to a findings input screen used in Embodiment 1 and Embodiment 2.

FIG. 23 is an example of data structure for findings input information.

FIG. 24 is an example of a findings input screen.

FIG. 25 is an example of a billing information statement.

FIG. 26 is a flow chart showing Embodiment 2.

FIG. 27 is a flow chart showing Embodiment 2.

FIG. 28 is a flow chart showing Embodiment 2.

FIG. 29 is an example of a search template.

FIG. 30 is an example of a similar case table.

FIG. 31 is an example of a similar case table for quality evaluation.

FIG. 32 is a flow chart showing Embodiment 2.

FIG. 33 is a configuration diagram of hard system according to Embodiment 1 and Embodiment 2.

### DETAILED DESCRIPTIONS OF EMBODIMENTS

Below, embodiments of the present invention will be explained with reference to figures.

### Embodiment 1

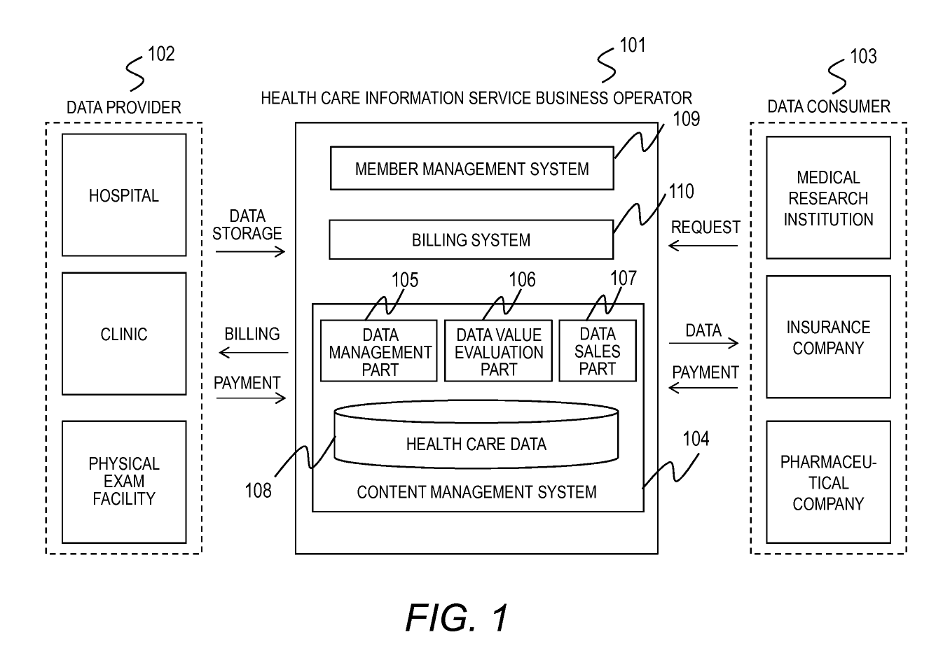

FIG. 1 shows a configuration of the entire system of this embodiment. A health care information service business operator 101 provides a data provider 102 with a service to store clinical data such as medical condition data or check-up data of patients, which is provided by the data provider 102. On the other hand, a data consumer 103 purchases necessary clinical data out of the clinical data stored by the health care information service business operator, and uses such data for research and development. The health care information service business operator selects clinical data that matches criteria (clinical data items, quality, quantity, and the like) requested by the data consumer, and provides such data to the data consumer. The health care information service business operator 101 changes the price of data depending on the conditions of data to be provided to the data consumer, and also changes the cost of storing the data provided by the data provider depending mainly on the data items, quality, quantity.

The health care information service business operator 101 includes a content management system 104, a member management system 109, and a billing system 110. The content management system 104 includes a data management part 105 that manages data provided by the data providers, a data value evaluation part 106 that evaluates the value of data provided by the data providers based mainly on the data quantity, quality, and items, a data sales part 107 that manages sales of data to each data consumer 103, and a storage 108 that stores therein health care data managed by the data management part 105. The member management system 109 manages data providers 102 and data consumers 103 that receive the service of the health care information service business operator 101. The billing system 110 manages billing information such as data storage fees for the data providers 102 and data purchasing fees for the data consumers 103.

The data providers 102 are hospitals, medical care providers, medical examination facilities, and the like, and the data providers 102 ask the health care information service business operator to store various types of data generated therein such as clinical data (disease name of, symptoms of, medical practice for, and prescription for each patient) and medical exam data (medical care provided at a regular physical exam and the like). The data storage fee is charged by the health care information service business operator to the data providers, and each data provider pays the data storage fee to the health care information service business operator via bank transfer or the like.

The data consumers 103 are medical research facilities, insurance companies, and pharmaceutical companies. The data consumers 103 ask the health care information service business operator to provide necessary data out of the data provided by the data providers for researches on the treatment of patients, maintenance and preventive measures to improve health conditions, selection of test subjects for clinical trials, and the like. After receiving the requested information, the data consumer pays the fee (data purchasing fee) for the data to the health care information service business operator. This payment is a profit of the health care information service business operator, and this payment is also used to offer a discount on the data storage fee, which is paid by the data providers to the health care information service business operator. This allows the data providers to store clinical data at low cost, which motivates the data providers to store more clinical data at the health care information service business operator, and as a result, the data storage is promoted. On the other hand, if the data storage is promoted and a larger amount of data is stored, the necessary data is more likely to be available to the data consumers, and the data consumers can obtain desired data with greater ease.

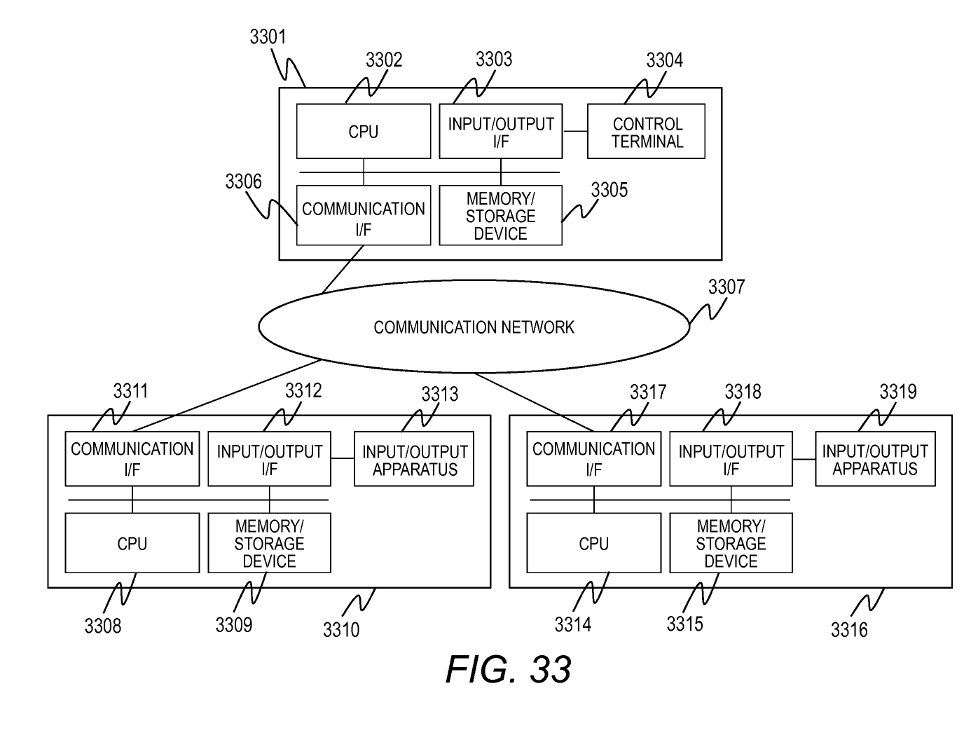

The hard system configuration that realizes FIG. 1 will be explained with reference to FIG. 33.

The health care information service business operator 101 is realized by executing programs (program for the member management system 109, program for the billing system 110, and programs for the content management system 104 that include program for the data management part 105, program for the data value evaluation part 106, and program for the data sales part 107) on a computer 3301 such as data center or server. The computer 3301 includes a CPU 3302 that is a computing device that executes the programs and processes data, a memory/storage device 3305 that stores therein the above-mentioned programs, data, and the like (the storage 108 of FIG. 1 is disposed here), a communication interface 3306 that exchanges data with the data providers and the data consumers through communication network 3307 such as a communication line, the Internet, or the like, an input/output interface 3303 coupled with a control terminal 3304, and the like. The control terminal (control device) includes an input/output device, through which an operator inputs programs and data into the computer or the storage status of the clinical data in the storage, the billing status, and the like is displayed.

The data provider 102 sends, via a computer 3310 of the data provider 102, clinical data in a prepared format, which was entered by doctors, health consultants, or the like from an input/output device 3313 through an input/output interface 3312, to the health care information service business operator through a communication line or the like. The computer includes a CPU 3308, a memory/storage device 3309, a communication interface 3311 for the communication network 3307, the input/output device 3313, the input/output interface 3312 for the input/output device, and the like, and by executing programs stored in the memory/storage device, the computer takes in the clinical data entered through the input/output device, and the clinical data is sent to the health care information service business operator. The computer of the data provider may also be configured such that when receiving an invoice for the data storage fee issued by the computer of the health care information service business operator, a payment instruction is automatically sent to a bank so that the payment is made from the bank to the health care information service business operator.

The data consumer 103 sends, via a computer 3315 of the data consumer, a request message/signal/packet or the like that includes a request for specific clinical data to the computer of the health care information service business operator. The computer of the data consumer 103 also receives and stores the requested clinical data sent from the computer of the health care information service business operator. By analyzing this stored clinical data, the data consumer can conduct researches and health promotion activities. The computer 3315 includes a CPU 3314, a memory/storage device 3315, a communication interface 3317 for the communication network 3307, an input/output device 3319, an input/output interface 3319 for the input/output device, and the like, and by executing programs saved in the memory/storage device, the computer sends a request for necessary data to the health care information service business operator, and receives requested data. The computer of the data consumer may also be configured such that when receiving the requested clinical data, a payment instruction is automatically sent to a bank so that the payment is made from the bank to the health care information service business operator.

Below, the configuration of the data handled by the system that realizes above-mentioned functions will be explained.

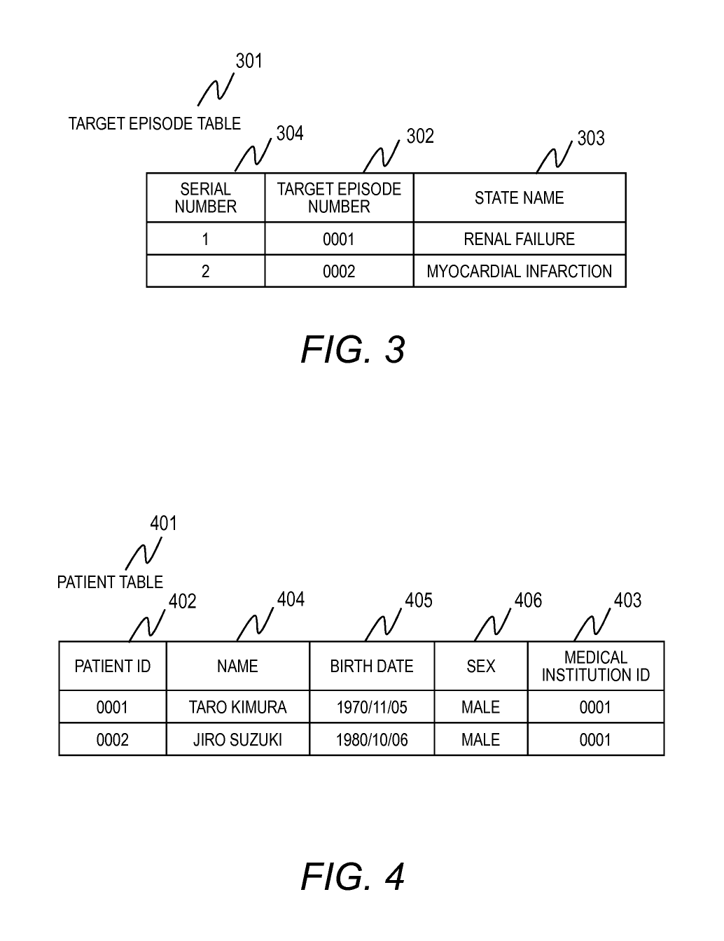

FIG. 3 shows a target episode table 301. This table includes serial number 304 for each entry, target episode number 302 for identifying an episode conducted a data value evaluation process and the like, and state name 303 that represents such an episode. The target episode number is specified by each state name. The state name includes disease name, physical finding name, and treatment plan name such as administration of anticancer drug. A regular physical examination may be included in the state name. This table, a master table to manage episodes conducted a data value evaluation process and the like, is created by the data management part 105 in accordance with the health care information service business operator's input through the control terminal 3304. The health care information service business operator creates this target episode table, thereby specifying the data target to be collected. Data provided by the data providers is sorted and managed by each target. For example, this table is used only for episodes needed more by the data consumers so as to limit the number of episodes that conduct the data value evaluation process and the like, all episodes are may be registered.

FIG. 4 shows a patient table 401. This table is a master table to manage basic information of each patient, and includes patient ID 402 for identifying each patient, patient name 404, patient birth date 405, patient sex 406, and medical institution ID 403 that is an identifier for each medical institution at which patients are under care. This data is provided by the data providers 102 to the health care information service business operator 101 and the data management part 105 stores this data in the storage 108.

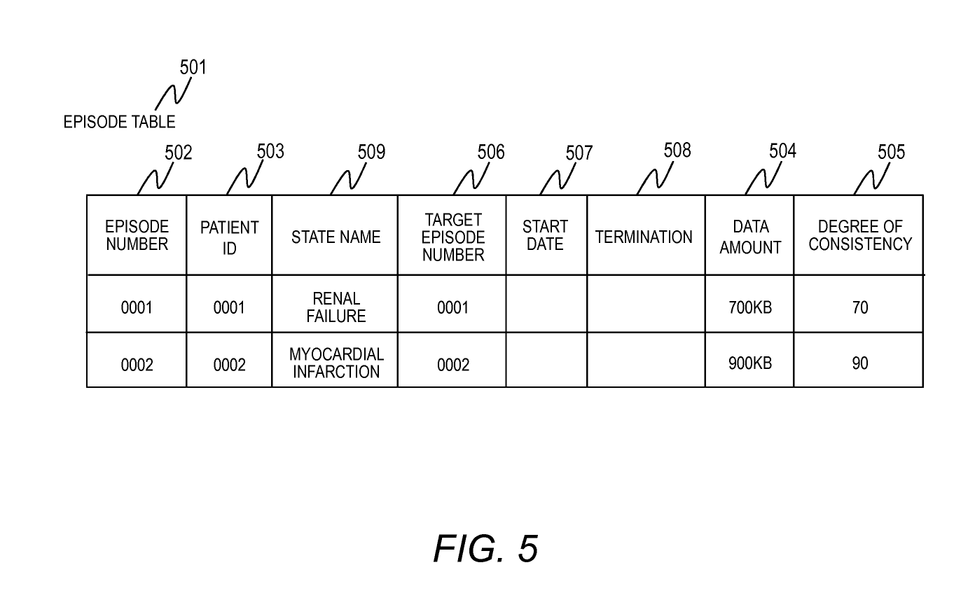

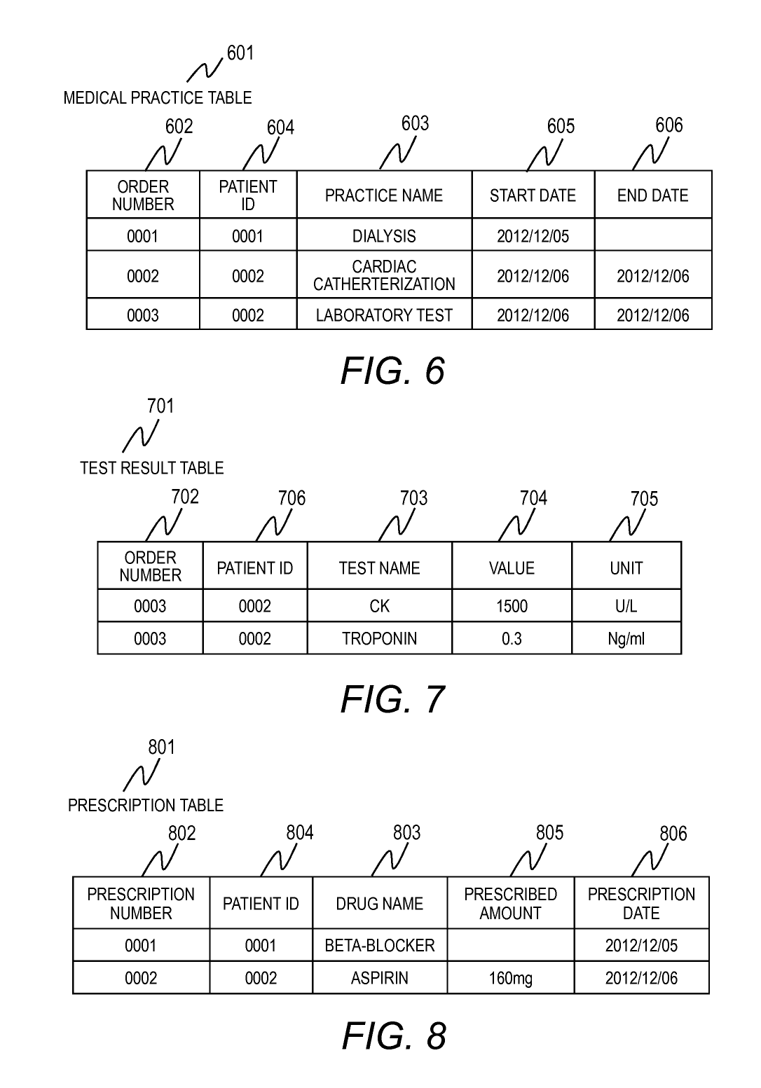

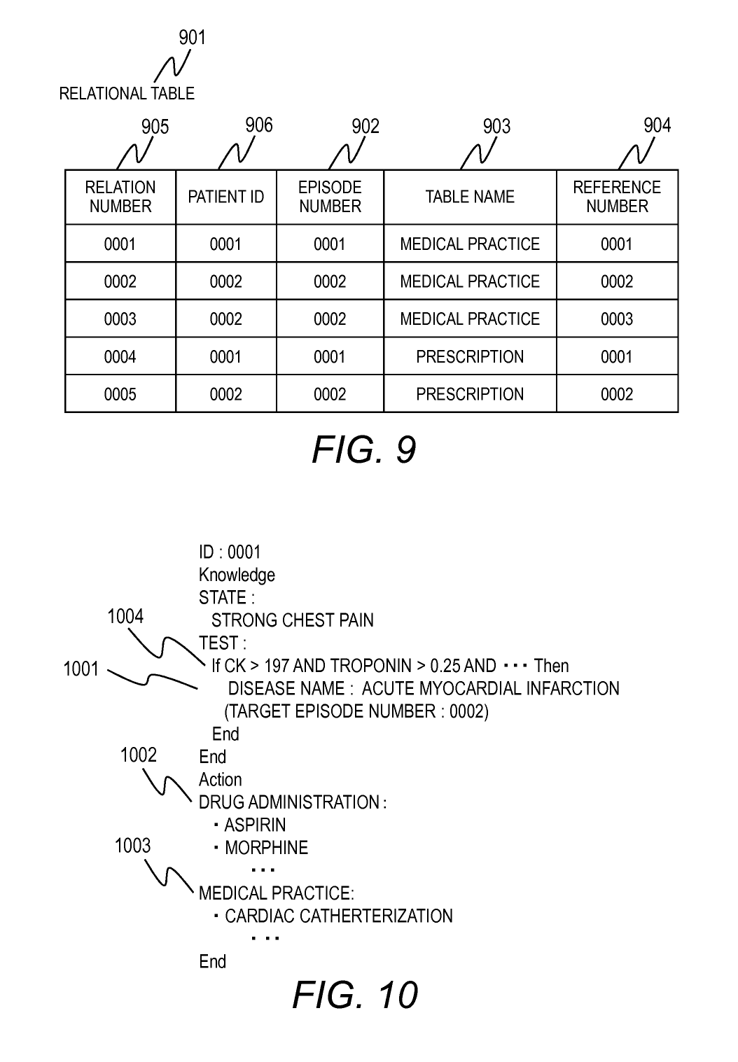

FIG. 5 shows an episode table 501. This table includes episode number 502 that is a serial number for each entry, patient ID 503 for identifying each patient, state name 509 that represents an episode, target episode number 506 for referring to the target episode table of FIG. 3 for the record corresponding to the state name, start date 507 of an episode, termination 508 that is a result of each episode such as recovery or death, data amount 504 that is the total amount of data relating to each episode, and consistency 505 of the data calculated based on the diagnosis medical knowledge for the data relating to each episode. The target episode number 506 is blank if the target episode table of FIG. 3 does not have the corresponding state name. The data amount is the total byte of all records relating to a certain episode included in a relational table of FIG. 9, a medical practice table of FIG. 6, a test result table of FIG. 7, and a prescription table of FIG. 8.

FIG. 6 shows the medical practice table 601. This table includes order number 602 that is a serial number for each entry, patient ID 604 for identifying each patient, practice name 603 indicating the medical practice performed on a patient, and start data 605 and end date 606 of the medical practice. The practice name 603 includes names of medical practice such as test, treatment, surgery, and the like.

FIG. 7 shows a test result table 701. This table manages the result of laboratory tests in the medical practice table of FIG. 6, and includes order number 702 to link each result to a laboratory test in the medical practice table, patient ID 706 for identifying each patient, test name 703 that is a name of the test, and value 704 indicating numerical values representing the results of the respective test names, and unit 705 of the numerical values. Usually, a plurality of tests are conducted in one laboratory test, and therefore, a plurality of records having a same order number may exist. FIG. 6 shows the case in which two records having the same order number exist.

FIG. 8 shows a prescription table 801. This table includes prescription number 802 that is a serial number for each entry, patient ID 804 for identifying each patient, drug name 803 of a prescribed drug, prescribed amount 805 of the drug, and prescription date 806.

FIGS. 6, 7, and 8 are records for the medical practice performed on a certain patient, but only with these tables, it is not possible to determine which medical practice relates to which episode. A relational table 901 of FIG. 9 is used to identify this relationship. This table 901 includes relational number 905 that is a serial number for each entry, patient ID 906 for identifying each patient, episode number 902 to refer to the target episode in the episode table of FIG. 5, table name 903 for specifying a corresponding table, which is either the medical practice table of FIG. 6 or the prescription table of FIG. 8, and reference number 904 for referring to the records in the table specified by the table name. The reference number 904 corresponding to the order number 602 of the medical practice table 601 of FIG. 6 is referred if the table name is medical practice, and the reference number 904 corresponding to the prescription number 802 of the prescription table 801 of FIG. 8 is referred if the table name is prescription.

Data of FIGS. 4 and 5 except for the data amount and consistency (episode number, patient ID, target episode number, start date, and termination) and data of FIGS. 6, 7, 8, and 9 are provided by the data providers to the health care information service business operator, and after received from the computer of each data provider through the network, the data management part stores such data into each table in the memory based on the type of the received data.

FIG. 10 shows an example of diagnosis medical knowledge. In the example shown in FIG. 10, the diagnosis medical knowledge has the file structure, and includes a plurality of items such as a state indicating the symptoms of the patient (such as “strong chest pain”), a test typically conducted for such a state and names of possible diseases determined based on the test result (section 1001), medication (names of drug) typically administered to the patient for such a state such as “aspirin” or “morphine” (section 1002), a medical practice (names of medical practice) typically conducted for such a state such as “cardiac catheterization” (section 1003), and the criteria for determining the name of the disease based on the test result (CK>197, troponin>0.25) (section 1004). This diagnosis medical knowledge is the knowledge widely recognized as correct in the health care field. The health care information service business operator stores in advance such knowledge for various symptoms in the storage 108 via the control terminal 3304, for example. This diagnosis medical knowledge is used to evaluate the quality of clinical data provided by the data providers. The quality/value of the clinical data is evaluated based on the degree of consistency with the diagnosis medical knowledge.

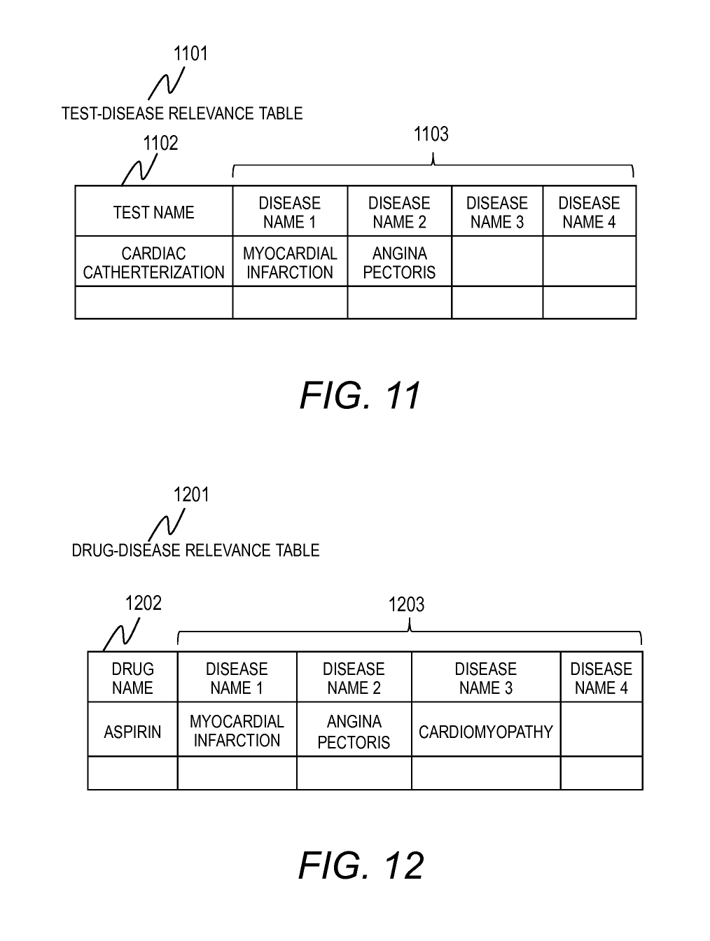

FIG. 11 shows a test-disease relevance table 1101. This table is a master table to manage diseases relevance corresponding to the respective tests, and is a part of the diagnosis medical knowledge. This table includes test name 1102 and names of diseases relevant to the test. Here, if a name of a disease is relevant to a test, this means that, when the patient is suspected to have the disease (1103), the implementation of the test is appropriate. Similar to FIG. 10, the health care information service business operator stores in advance the test-disease relevance table in the memory via the data management part 105. This diagnosis medical knowledge is used to evaluate the quality of clinical data provided by the data providers. The quality of the clinical data is evaluated based on the degree of consistency with the diagnosis medical knowledge.

FIG. 12 shows a drug-disease relevance table 1201. This table is a master table to manage diseases relevance corresponding to respective drugs, and is a part of the diagnosis medical knowledge. This table includes drug name 1202 and names of diseases relevant to each drug. Here, if a name of a disease is relevant to a drug, it means that, when the patient is suspected to have the disease, the administration of the drug is appropriate. Similar to FIG. 10, the health care information service business operator stores in advance the test-drug relevance table in the memory via the data management part 105. This diagnosis medical knowledge is used to evaluate the quality of clinical data provided by the data providers. The quality of the clinical data is evaluated based on the degree of consistency with the diagnosis medical knowledge.

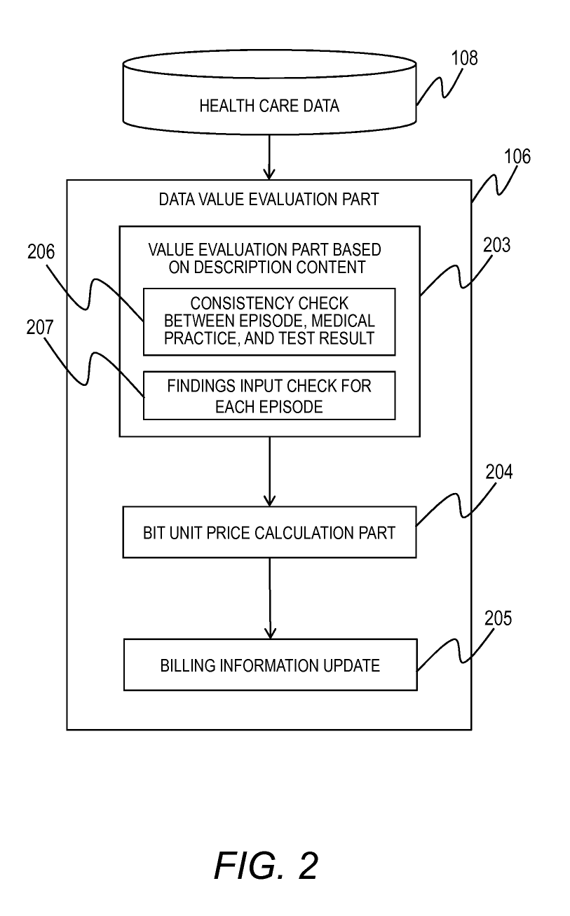

FIG. 2 shows a process flow of the data value evaluation part 106 (program) executed by the CPU of the computer of the health care information service business operator. The data value evaluation part 106 conducts a process to evaluate the data value of the health care (clinical) data stored in the storage 108 by the data management part 105. The data value evaluation part 106 includes a value evaluation part 203 that evaluates the value of data based on the content of the data provided by the data providers 102, a bit unit price calculation part 204 that calculates the bit unit price for the data storage based on the evaluated data value, and a billing information updating part 205 that updates the amount to be billed based on the bit unit price.

The value evaluation part 203 based on the content of the data includes a step 206 to check whether or not various types of data such as episodes, medical practice, and test results are collected for the requested subject, item, content and quality (for example, check for the consistency with the predetermined indicators or pre-defined items), and a step 207 to check whether or not findings (such as test item, test result, and prescription) are entered for each episode. The findings are entered through a free text data template input. The bit unit price calculation part 204 calculates the bit unit price for the data storage of the data provider based on the evaluated data value, and the billing information updating part 205 notifies the billing system 110 of FIG. 1 of the bit unit price information calculated by the bit unit price calculating part 204.

As described above, the data value evaluation part evaluates data provided by the data providers, calculates the bit unit price for the data storage based on the evaluation results, and determines the storage fee. Because the bit unit price is determined by evaluating data, by making the storage fee for the data with better evaluation result lower than the storage fee for the data with poor evaluation result, for example, it is possible to encourage the data providers to provide high-quality data to reduce the data storage fee. This allows the health care information service business operator to collect high-quality data effectively.

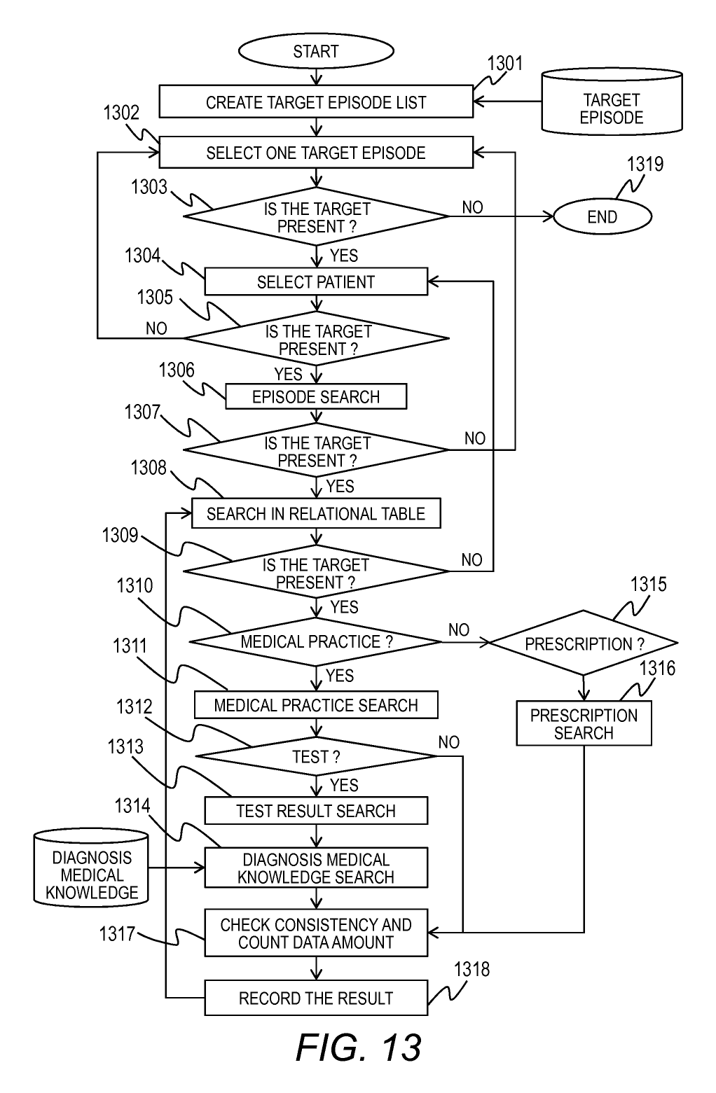

FIG. 13 shows a process flow of the consistency check 206 conducted by the value evaluation part 203 based on the description content, In Step 1301 by the value evaluation part 203 based on the description content, all records are acquired from the target episode table 301 of FIG. 3 and managed in the memory 3305 as a list of episodes to be processed. In Step 1302, one target episode (target episode number) is selected from the list. In Step 1303, if there is a target episode, the process moves to Step 1304. If there is no target episode, the process is ended after proceeding to Step 1319.

In Step 1304, one record is acquired from the patient table 401 of FIG. 4, thereby selecting a patient (patient ID). In Step 1305, if there is a patient, the process moves to Step 1306. If there is no patient, the process returns to Step 1302.

In Step 1306, based on the patient ID 402 in the record selected in Step 1304 and the target episode number 302 in the record selected in Step 1302, episodes corresponding to the patient are looked up in the episode table 501 of FIG. 5, and one of the episodes is selected. Specifically, records/episodes corresponding to the patient ID 503 and the target episode number 506 in the episode table 501 are selected.

In Step 1307, if there is a record/episode, the process moves to Step 1308. If there is no record/episode, the process returns to Step 1302. If there is an episode, data for this episode (or patients corresponding to the target episode) is the data to be evaluated for the consistency.

In Step 1308, a record relating to the episode/record selected in Step 1306 is looked up in the relational table 901 of FIG. 9 based on the episode number 502. Specifically, a record in the relational table 901 in which the episode number 902 matches the episode number 502 is selected. In Step 1309, if such a record exists, the process moves to Step 1310. If such a record does not exist, the process returns to Step 1304.

To summarize the procedures from Step 1301 to Step 1309, for the data stored as per request of the data provider, whether or not a patient exists for each state name 303 is determined first, and if there is such a patient, then the combination (state name 303 and patient (patient ID)) is selected. When there are a plurality of target episodes and there are a plurality of patients, one combination is successively selected every time Step 1310 to Step 1318 are conducted.

In Step 1310, if the table name 903 of the record is the medical practice, the process moves to Step 1311. If not the medical practice, the process moves to Step 1315.

When the table name 903 of FIG. 9 is the “medical practice,” the order number 602 for the record selected in Step 1308 is looked up in the medical practice table 601 of FIG. 6 based on the reference number 904 (Step 1311). Specifically, a record in which the reference number 904 matches the order number 602 is searched for, and the practice name 603 such as “dialysis,” “cardiac catheterization,” or “laboratory test” is obtained. Next, in Step 1312, if the practice name 603 for the record found in Step 1311 is “laboratory test,” the process moves to Step 1313, and if not, the process moves to Step 1317. In case of the “laboratory test” (Step 1313), a record is looked up in the test result table 701 of FIG. 7 based on the reference number of the record selected in Step 1308. Specifically, the test result table 701 is searched for a record in which the reference number matches the order number 702. For the matched record, the test name 703, which is the name of the test, the value 704, which is the test result (numerical value), and the unit 705 of the numerical value indicating the test result are obtained.

In Step 1314, the diagnosis medical knowledge shown in FIG. 10 is searched for. In the search process of Step 1314, a file in which the episode number in the disease name section 1001 of FIG. 10 matches the target episode number 302 selected in Step 1302 is searched for. The diagnosis medical knowledge contained in the file is used to evaluate the quality of clinical data provided by the data provider, which is specified by the target episode number and the patient ID selected in the steps described above.

If the table name 903 of FIG. 9 is not “medical practice”, whether or not the table name 903 of the record selected in Step 1308 is “prescription” is determined in Step 1315, and if the table name 903 is “prescription,” the process moves to Step 1316. In Step 1316, the test result table 801 of FIG. 8 is searched for a record matching the reference number of the record selected in Step 1308. Specifically, a record in which the reference number matches the prescription number 802 of the prescription table 801 is searched for. Then the drug name 803 (such as “beta-blocker”) for the matched record is obtained. If the table name 903 is not “prescription” in Step 1315, or in other words, if the selected record is neither “medical practice” nor “prescription,” the process for this record is ended, and the process flow returns to Step 1308.

In Step 1317, based on the diagnosis medical knowledge file selected in Step 1314, the test-disease relevance table 1101 of FIG. 11, and the drug-disease relevance table 1201 of FIG. 12, the consistency is checked for the medical practice name, test results, and prescribed drug, which were obtained in Step 1311, Step 1313, and Step 1316, respectively. That is, the degree of consistency between the medical practice, test results, and prescribed drug for a certain state name and the medical knowledge prepared in advance (FIGS. 10, 11, 12) (medical criteria prepared in advance) is checked.

In Step 1317, the byte count of all records relating to the target episode number of Step 1306 is obtained from the episode table 501 of FIG. 5, the medical practice table 601 of FIG. 6, the test result table 701 of FIG. 7, the prescription table 801 of FIG. 8, and the relational table 901 of FIG. 9. That is, for the episode table of FIG. 5, the byte count of the records found as a result of searching for the target episode number 505 is obtained. For the relational table of FIG. 9, the byte count of the records found as a result of searching for records in which the episode number 902 matches the episode number 502 contained in the record of the found episode table is obtained. For the medical practice table of FIG. 6, the byte count of the records found as a result of searching for records in which the order number 602 matches the reference number 904 of the records in which the table name 903 is “medical practice” among the found records in the relational table is obtained. For the test result table of FIG. 7, the byte count of the records found as a result of searching for records in which the order number 702 matches the order number 602 of the records in which the practice name 603 is “laboratory test” among the found records in the medical practice table is obtained. For the prescription table of FIG. 8, the byte count of the records found as a result of searching for records in which the prescription number 802 matches the reference number 904 of the records in which the table name 903 is “prescription” among the found records in the relational table is obtained. Then, the total byte count of those records is obtained.

In the result recording process of Step 1318, the obtained consistency and data amount (byte count) are stored in the consistency 505 and the data amount 504 of FIG. 5, respectively.

Below, the consistency check process (Step 1317) will be explained based on specific examples. “Myocardial infarction” of the target episode number 0002 in the target episode table 301 of FIG. 3 will be explained as an example. The state name of the record of the episode number 0002 in the episode table 501 of FIG. 5 is “myocardial infarction.” For this episode (myocardial infarction (episode number 0002)), the relational table 901 of FIG. 9 has two records having the table name of “medical practice” and one record having the table name of “prescription.” The reference numbers of the medical practice are 0002 and 0003. In the medical practice table 601 of

FIG. 6, the reference numbers 0002 and 0003 of the medical practice correspond to the records of the order numbers of 0002 and 0003, and the respective medical practice names thereof are “cardiac catheterization” and “laboratory test.” The result of the laboratory test corresponds to the order number 0003 in the test result table 701 of FIG. 7, and this order number has two test names “CK” and “Troponin.” The values and units thereof are 1500 U/L for “CK” and 0.3 Ng/ml for “Troponin,” respectively. On the other hand, the reference number of the prescription for the episode number 0002 in the relational table 901 is 0002. The reference number 0002 of the prescription corresponds to the prescription number 0002 in the prescription table 801 of FIG. 8, and the record thereof shows aspirin as the drug name. To summarize the flow described above, information indicating that the cardiac catheterization and laboratory test were conducted as the medical practice for the myocardial infarction of the episode number 0002; that the laboratory test was CK and troponin, and the result of CK was 1500 U/L and the result of troponin was 0.3 Ng/ml; and that aspirin was administered for the myocardial infarction was provided by the data provider to the health care information service business operator, and was stored in the memory. Based on the search results described above, the consistency check is conducted based on the test-disease relevance table 1101 of FIG. 11, the drug-disease relevance table 1201 of FIG. 12, and the diagnosis medical knowledge file of FIG. 10.

First, in the test-disease relevance table 1101, myocardial infarction is entered under the disease name 1 of an item 1103 as the disease relevant to the cardiac catheterization under the test name 1102, which is consistent with the cardiac catheterization of the episode number 0002. Next, in the drug-disease relevance table 1201, myocardial infarction is entered under an item 1203 as the disease relevance to aspirin under the drug name 1202, which is consistent with aspirin of the episode number 0002.

Next, the consistency is checked based on the diagnosis medical knowledge file of FIG. 10. First, in the section 1001, the target episode number 0002 is entered, which is consistent with the record. In the drug administration of the section 1002, aspirin is entered, which is consistent with the record, but morphine is not prescribed. In the medical practice of the section 1003, cardiac catheterization is entered, which is consistent with the record. In the test result judgment of the section 1004, CK>197 and troponin>0.25, and because the episode number 0002 meets those criteria, the consistency is confirmed.

As described above, the record of the episode number 0002 is consistent with the diagnosis medical knowledge file of FIG. 10 except that morphine is not prescribed. The degrees of consistency are set as follows. If the record is consistent with the test-disease relevance table 1101, the degree of consistency is 0.3. If the record is consistent with the drug-disease relevance table 1201, the degree of consistency is 0.3. If the record is completely consistent with the diagnosis medical knowledge file of FIG. 10, the degree of consistency is 0.4, and if the record is partially consistent with the diagnosis medical knowledge file, the degree of consistency is 0.3. In case of the episode number 0002, the degree of consistency with the diagnosis medical knowledge file is 0.3, and overall, the degree of consistency is 0.9. Those values of consistency can be manually changed based on the analysis result and the like of past data.

Lastly, in Step 1318, the degree of consistency and data amount obtained in Step 1317 are recorded in the consistency 505 and the data amount 504 in the episode table 501 of FIG. 5, respectively

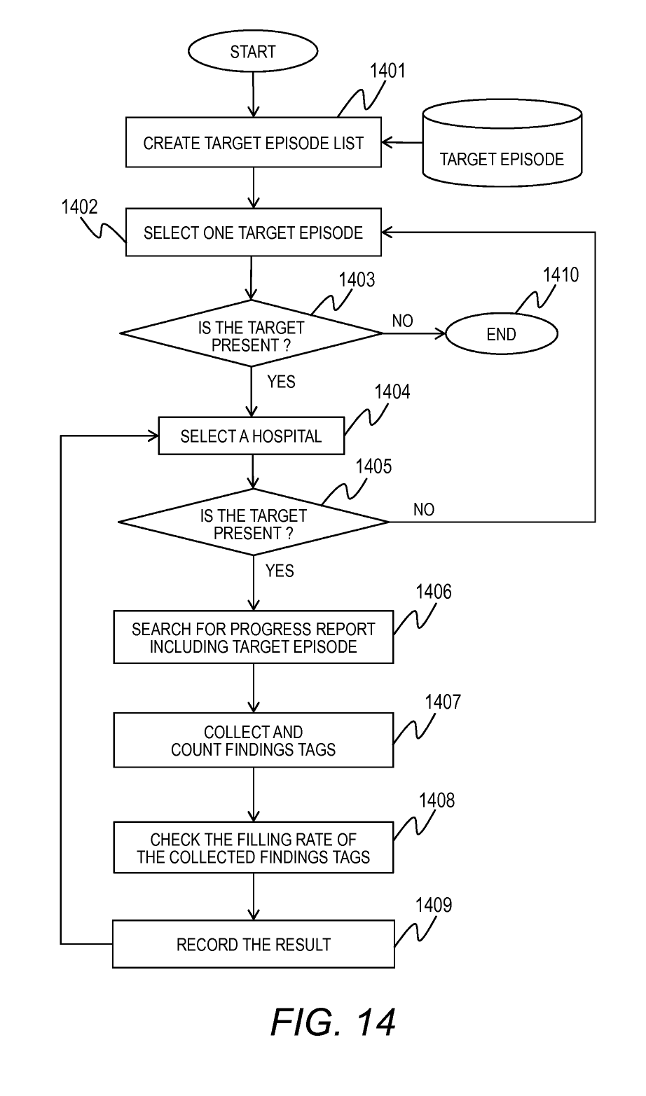

FIG. 14 shows a process flow of the findings input check 207 for each episode conducted by the value evaluation part 203 based on the description content. This process is executed in the computer of the health care information service business operator. First, the data used in the process flow of FIG. 14 will be explained.

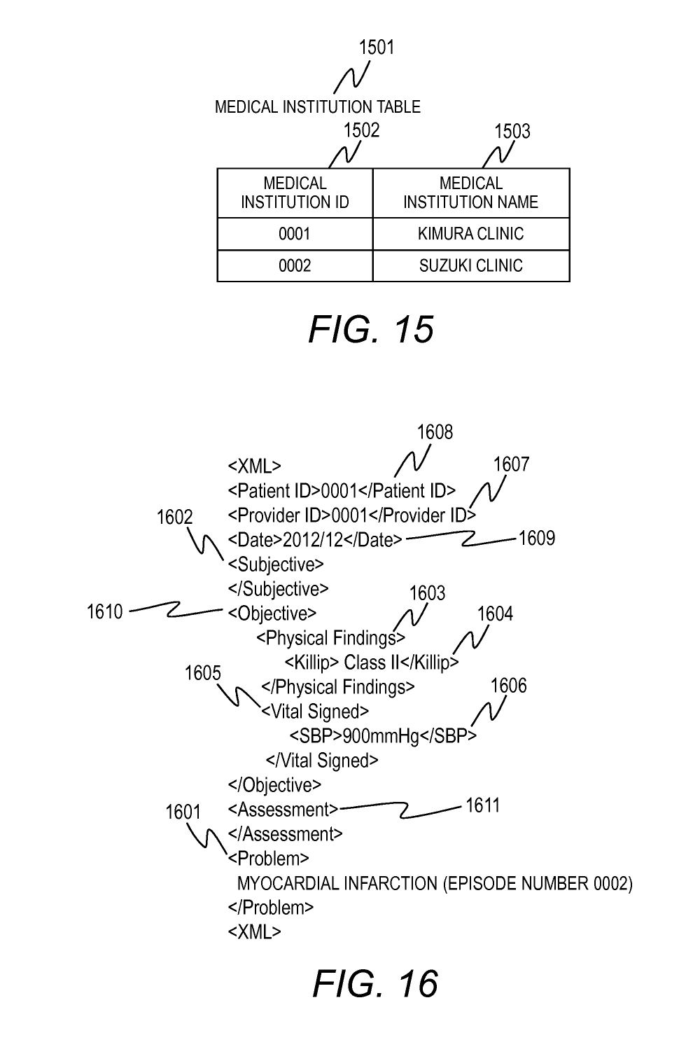

FIG. 15 shows a medical institution table 1501. This table is a master table to manage medical institutions, which are data providers, created by the member management system, 109 in accordance with the health care information service business operator's input, and includes medical institution ID 1502 for identifying each medical institution, and medical institution name 1503.

FIG. 16 is a progress record file of the clinical data, and shows an example of data items and data format when the data provider 102 requests the health care information service business operator to store a progress record of treatment and the like. The data items include patient ID (identifier) <Patient ID> 1608 for identifying a patient, medical institution ID <Provider ID> 1607 for identifying each hospital, clinic, or diagnosis facility, date <Date> 1609 for identifying year, month, and day, <Subjective> 1602 that is a comment from the patient, <Objective> 1610 that is findings of a doctor, <Assessment> 1611 that is an interpretation of the doctor, and <Problem> 1601 that is a disease name. The above-mentioned findings include a type of test, test result, medical practice, and medication labeled <Physical findings> 1603, <Vital Signed> 1605, and the like, and can be freely added depending on the items or content of the findings. The data format structure is the XML structure shown in the figure, for example.

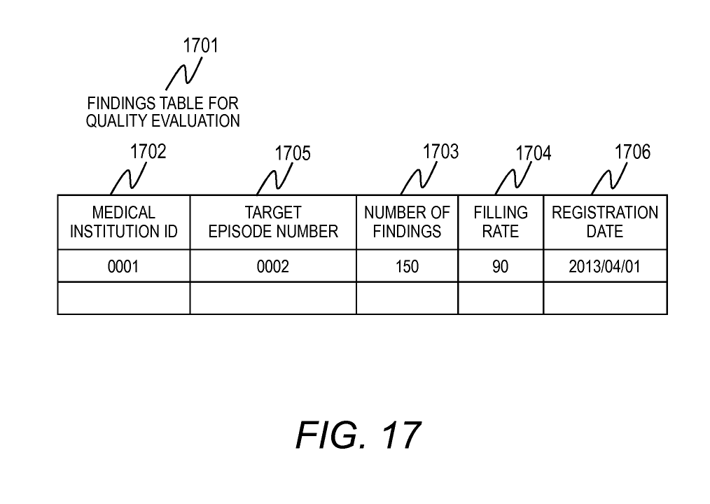

FIG. 17 shows a findings table for quality evaluation 1701. This table manages evaluation indicators for evaluating the quality of data based on the findings for each medical institution which is the data provider. This table includes medical institution ID 1702 for identifying a medical institution to be evaluated, target episode number 1705 for identifying a target episode to be evaluated, number of findings 1703 that is the number of findings included in a progress record for the target episode, a filling rate 1704 that is a ratio of the descriptions of the findings to the progress record for the medical institution and for the target episode, and a registration date 1706 on which the number of findings and the filling rate were entered. The data in this table is generated in the findings input check 207 for each episode conducted by the data value evaluation part 106 of the health care information service business operator.

In Step 1401 of FIG. 14, all records are obtained from the target episode table 301 of FIG. 3, and are managed in the memory as a list of episodes to be processed. In Step 1402, one target episode is selected from this list. In Step 1403, if there is a target episode, the process moves to Step 1404, and if there is no target episode, the process is ended after proceeding to Step 1410.

In Step 1404, one record is acquired from the medical institution table 1501 of FIG. 15, thereby selecting a medical institution. In Step 1405, if there is a medical institution, the process moves to Step 1406. If there is no medical institution, the process returns to Step 1402.

In Step 1406, all progress record files for the target episode selected in Step 1402 and the medical institution ID selected in Step 1404 are looked up in the storage 108 of FIG. 1 in which the health care data is stored. Specifically, for the progress record file having the structure of FIG. 16, Problem tag 1601 and Provider ID tag 1607 are checked, and all files that include the medical institution ID and the target episode are looked up in the storage 108 of FIG. 1.

In Step 1407, tags included in the Objective tag 1610 in the progress record files collected in Step 1406 are checked and the quantity thereof is counted. In this example, the Objective tag is checked in Step 1407, but the tag to be checked is not limited to Objective, In FIG. 16, Killip tag 1604 exists in the Physical Findings tag 1603. This indicates the Killip classification of the left ventricular failure caused by the acute myocardial infarction. Class II indicates a heart failure (such as rales or crackles in 50% or less of the lungs). In the Vital Signed tag 1605, SBP tag 1606 exists. This indicates systolic blood pressure. As described above, in FIG. 16, there are two findings tags. This search process is conducted for all progress record files collected in Step 1406.

In Step 1408, a ratio of the actual description in the findings tags collected in Step 1407 to all progress record files collected in Step 1406 is obtained. In FIG. 16, Class II exists under the Killip tag, and 900 mmHg exists under the SBP tag. In a case in which Killip tag and SBP tags are the only findings tags collected in Step 1407, because both have descriptions thereunder, the filling rate is 100%. If only one of them had a description thereunder, the filling rate would be 50%.

In Step 1409, the target episode selected in Step 1402, the medical institution ID of the medical institution selected in Step 1404, the quantity of findings tags for the medical institution counted in Step 1407, and the filling rate obtained in Step 1408 are entered in the medical institution ID 1702, the number of findings 1703, and the filling rate 1704 of the findings table for quality evaluation of FIG. 17, respectively. The registration date 1706 that is a date on which the data are registered is entered. After recording the results, the process returns to Step 1404, and another hospital is selected.

Step 1402 to Step 1410 are repeated until the calculation and the recording of the filling rate is completed for all target episodes and all hospitals.

As explained above with reference to FIG. 14, the filling rate of data provided by the date provider can be recorded for each target episode of each hospital. As a result, it is possible to evaluate the quality of clinical data based on the filling rate.

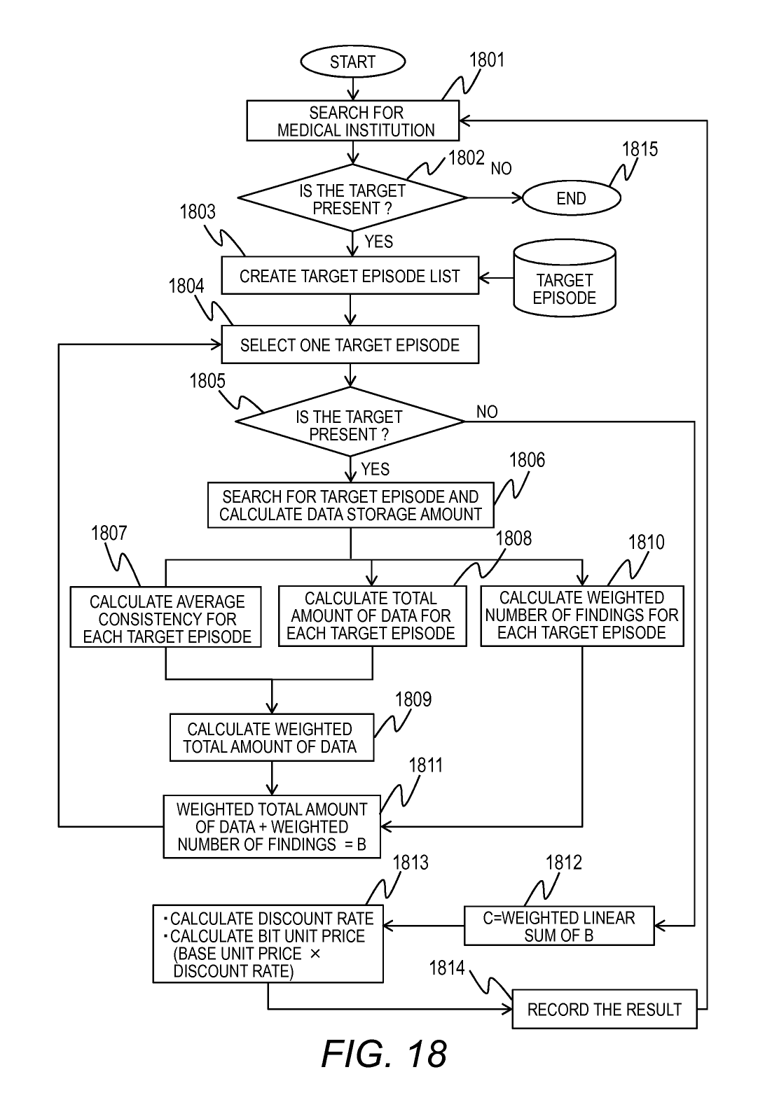

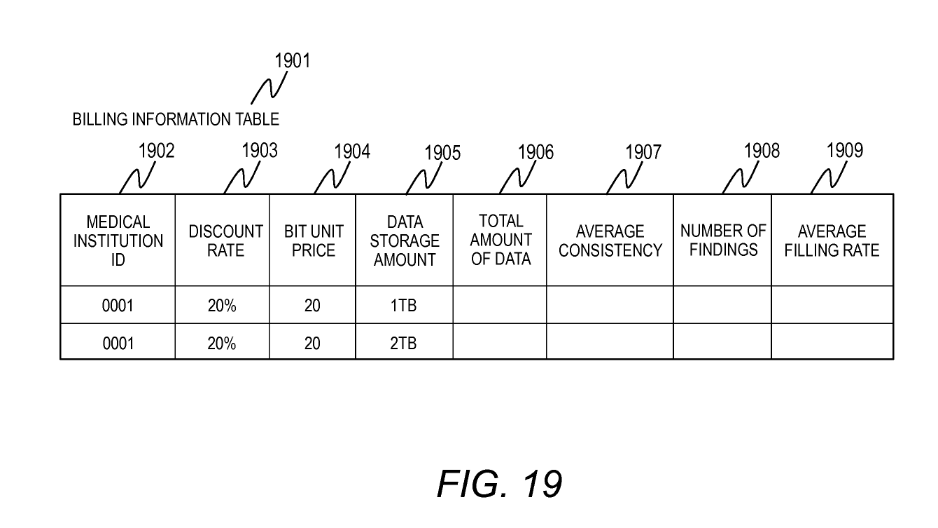

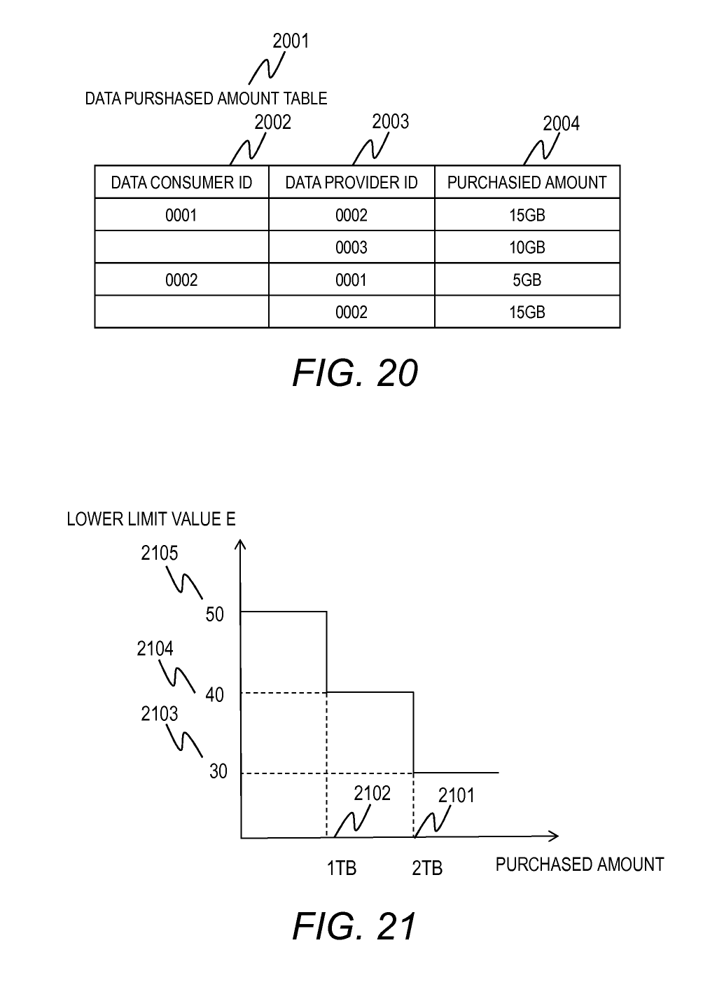

FIG. 18 shows a process flow of the hit unit price calculation part 204 executed by the computer of the health care information service business operator. First, tables (FIGS. 19 and 20) used in this process flow will be explained.

FIG. 19 shows a billing information table 1901. This table manages the bit unit price 1904 that determines the data storage fee, and evaluation is information required to calculate the bit unit price for each medical institution, which is the data provider 102. This table includes medical institution ID 1902 for identifying a medical institution, discount rate 1903 that is a numerical value indicating a percentage of discount from the base price, which is the bit unit price 1904 without discount, data storage amount 1905 of the medical institution, total amount of data 1906 indicating the amount of data after adjusting the data storage amount based on the value of the data, average consistency 1907 that is an average value of the consistency for the medical institution, which was obtained by checking the consistency with the diagnosis medical knowledge, number of findings 1908 that is the number of findings, and average filling rate 1909 indicating the ratio of the findings to the progress record of the medical institution. The data in this table is generated by the data value evaluation part 106 of the health care information service business operator.

FIG. 20 shows a data purchased amount table 2001. This table manages the amount of data purchased by each data consumer 103 for each data provider, and includes data consumer ID 2002 for identifying a data consumer, data provider ID 2003 for identifying a data provider, and purchased amount 2004 that indicates the amount of data purchased from the data provider. The data in this table is generated by the data sales part 107 of the health care information service business operator based on the data sales history.

In Step 1801 of FIG. 18, the bit price unit calculation part 204 acquires one record from the medical institution table 1501 of FIG. 15, thereby selecting a medical institution. In Step 1802, if there is a medical institution, the process moves to Step 1803. If there is no medical institution, the process is ended after proceeding to Step 1815.

In Step 1803, all records are acquired from the target episode table 301 of FIG. 3, and are managed in the memory as a list of episodes to be is processed. In Step 1804, one target episode is selected from the list. In Step 1805, if a target episode exists, the process moves to Step 1806, and if a target episode does not exist, the process moves to Step 1812.

In Step 1806, the episode table 501 of FIG. 5, in which the data amount 504 and the consistency 505 are entered, and the findings table for quality evaluation 1701 of FIG. 17, in which the number of findings 1703 and the filling rate 1704 are entered, are searched for the information regarding the medical institution, based on the target episode selected in Step 1804.

First, as for the episode table 501 of FIG. 5, the patient table 401 of FIG. 4 is searched for patients corresponding to the medical institution ID 403, and a list of patients who went to the medical institution is created. Then, records that include the patient IDs from the patient list described above are extracted from the episode table 501 using the patient ID 503, and the extracted records are further narrowed down based on the target episode number 506. Next, the data amount 504 for all of the records narrowed down in the process above is retrieved and the sum is calculated. To summarize this procedure, Step 1806 calculates the sum of data amounts of all of the applicable patients selected based on the target episode for the selected medical institution.

Furthermore, in Step 1806, the number of findings 1703 of the records found and selected based on the target episode number 1705 is acquired from the findings table for quality evaluation 1701 of FIG. 17. Lastly, the sum of data amounts 504 of FIG. 5 is added to the number of findings of FIG. 17, thereby obtaining the data storage amount of the medical institution. That is, in Step 1806 of FIG. 18, the storage amount (sum of the total amount of data and the number of findings) of data stored in the memory for each target episode is calculated for the selected medical institution.

In Step 1807, the average of the consistency 505 (average consistency) for all the records selected from the episode table 501 in Step 1806 is calculated.

In Step 1808, the sum of the data amounts 504 for all the records selected from the episode table 501 in Step 1806 is calculated. This sum is the data storage amount of the data in the episode table of FIG. 5, the medical practice table of FIG. 6, the test result table of FIG. 7, the prescription table of FIG. 8, and the relational table of FIG. 9, and the data storage amount of Step 1806 is the value obtained by adding the number of findings to this sum. In Step 1809, the weighted total amount of data is obtained by multiplying the average consistency, which was obtained in Step 1807, by the sum of the data amount, which was obtained in Step 1808. That is, by weighting the actual data storage amount by the average consistency, the amount of data having a high degree of consistency can be calculated.

In Step 1810, a weighted number of findings is calculated by multiplying the number of findings 1703 by the filling rate 1704 for all of the records selected from the findings table for quality evaluation 1701 in Step 1806.

In Step 1811, the sum of the weighted total amount of data obtained in Step 1807 and the weighted number of findings obtained in Step 1810 is calculated (this sum is denoted by B).

In Step 1812, a linear sum for the target episode is calculated based on the sum of the weighted total amount of date and the weighted number of findings, which was obtained in Step 1811 for each target episode. The result thereof is denoted by C.

In Step 1813, the discount rate that determines the size of discount from the base price, which is a bit unit price without discount, is calculated, and the bit unit price is calculated by multiplying the base unit price by the discount rate.

The discount rate is calculated in the following manner using C. The data storage amount for the target medical institution is calculated using the total amount of the data for each target episode, which was obtained in Step 1806, and the ratio of C to the data storage amount of this medical institution is calculated (the resultant value is denoted by D). The ratio D indicates the ratio of important data to the total amount of data stored for the medical institution. Next, DE is calculated where E is a prescribed lower limit value. If D−E>0, DE is the discount rate. If D−E is equal to or smaller than 0, no discount is given. For example, when E=50, if D is 80%, 30% discount is applied. The lower limit value E is provided to control the range of the discount rate. For example, when E=50, the discount rate is from 1 to 50%, and when E=40, the discount rate is from 1 to 60%. That is, the lower the value E is, the greater the range of discount rate is.

In Step 1814, the discount rate and the bit unit price of the medical institution, which were obtained in Step 1813, are recorded in the discount rate 1903 and the bit unit price 1904 in the billing information table 1901 of FIG. 19. Also, sum of all the data storage amount corresponding to the target episodes found in Step 1803 obtained in Step 1806 is calculated and recorded in the data storage amount 1905. Average of all the consistency 505 of the episode table 501 of FIG. 5 corresponding to the target episodes found in Step 1803 is calculated and recorded in the average consistency 1907. Similarly, sum of all the data amount 504 of the episode table 501 of FIG. 5 corresponding to the target episodes found in Step 1803 is calculated and recorded in the total amount of data 1906. Sum of all the findings quantity 1703 of the findings table for quality evaluation 1701 of FIG. 17 corresponding to the target episodes found in Step 1803 is calculated and recorded in the findings quantity 1908. Average of the filling rate 1704 of the findings table for quality evaluation 1701 of FIG. 17 corresponding to the target episodes found in Step 1803 is calculated and recorded in the average filling rate 1909.

As described above, by conducting Steps 1803 to 1814 for the medical institution selected in Steps 1801 and 1802, data is entered in the items 1903 to 1909 for a certain medical institution in FIG. 19. By repeating these steps, data is entered in the items 1903 to 1909 for each of the medical institutions.

In the descriptions above, the calculation for the bit unit price (discount on the data storage fee for a data provider) based on the consistency and quality (filling rate of findings description) was explained, but below, a case in which a discount on the data storage fee is offered to the data provider having a greater amount of data purchased by data consumers will be explained. The prepared lower limit value E, which was explained in Step 1813 of FIG. 18, may be adjusted based on the amount of data purchased by data consumers 103.

FIG. 20 is a data purchased table 2001 provided to manage the amount of data purchased by each data consumer, which is controlled using data consumer ID 2002, and a data provider (controlled by data provider ID 2003) from which each data consumer has purchased data. The total value of the purchased amount 2004 is calculated for each data provider ID 2003.

FIG. 21 shows a case in which the lower limit value E varies based on the total value. In FIG. 21, for the purchased amount up to ITB (point 2102), the lower limit value E is 50, but as the purchased amount increases to 2TB (point 2101) and higher, the lower limit value E is lowered to 40 and then 30. The lower the lower limit value E is, the greater the discount rate is, and therefore, it is possible to construct a billing model in which a data provider 102 with a greater purchased amount can receive a greater discount by adjusting the setting of the lower limit value E. The lower limit value E is input by the health care information service business operator through the control terminal 3303 in advance and is stored in the memory/storage device 3305.

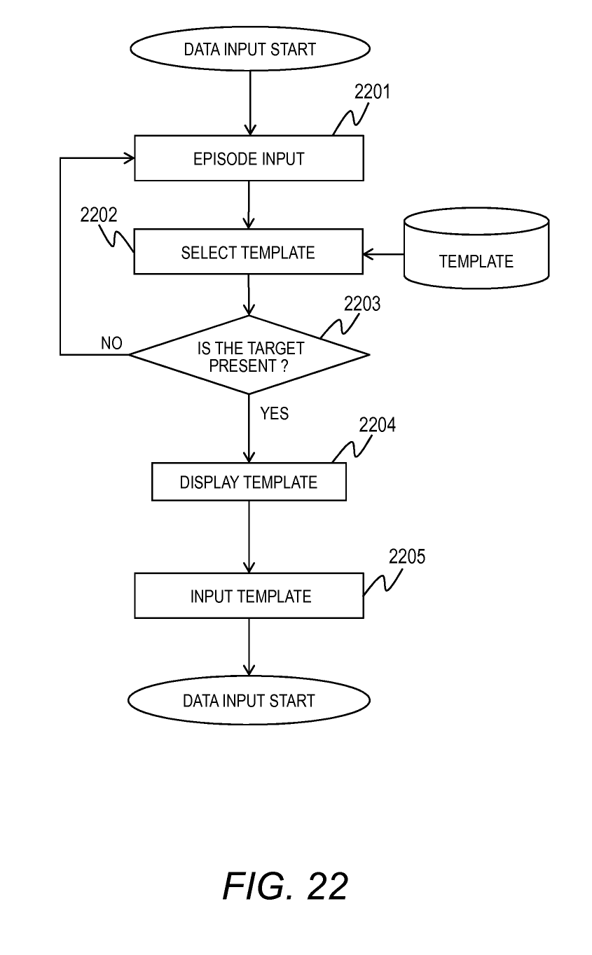

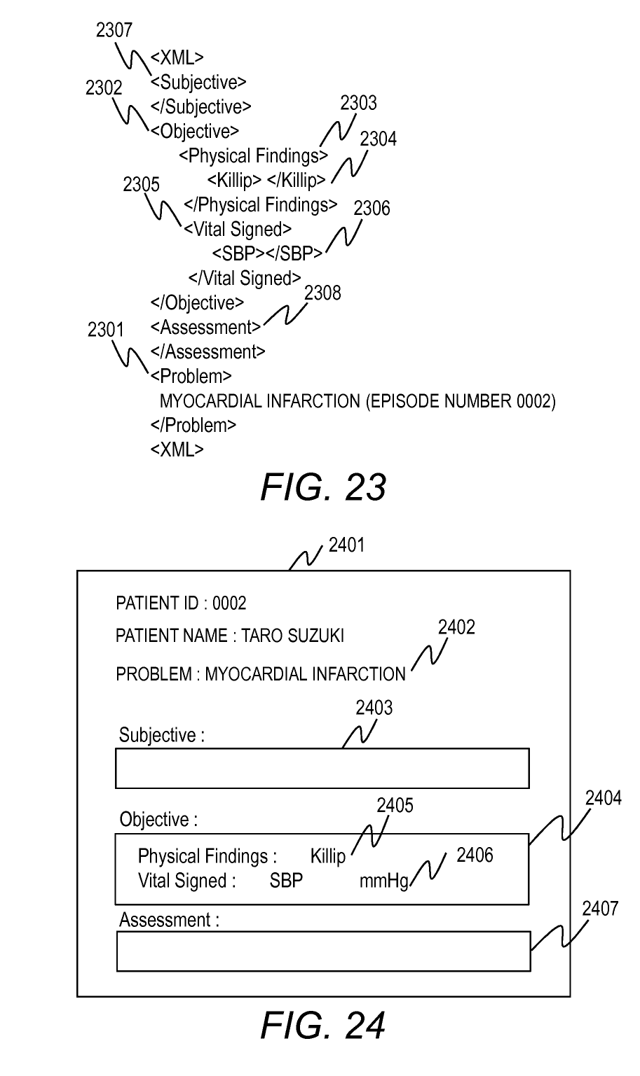

On the other hand, as for the input of data constituting the progress record file of FIG. 16 via the input/output interface of the data provider, an operation to present the findings information requested by data consumers 103 is considered. With this operation, the data providers are able to learn what kind of findings the data consumers want to see, and by increasing the amount of such findings data, the data providers can further increase the discount rate. This process flow will be explained with reference to FIG. 22. First, a method allowing the data consumers to specify requested items for findings will be explained with reference to FIG. 23, and the input screen through which the data providers input findings and the like will be explained with reference to FIG. 24. FIG. 23 is an XML file used by a data consumer to specify desired findings, and a template created by the data consumers. The data management part 105 stores, in the memory, the XML file received from a computer of a data consumer through network. This file includes a Subjective tag 2307, an Objective tag 2302, a Physical Findings tag 2303, a Killip tag 2304, a Vital Signed tag 2305, an SBP tag 2306, an Assessment tag 2308, and a Problem tag 2301. In this figure, “myocardial infarction (target episode number 0002)” is written in the Problem section defined by the Problem tag. Also because the Killip section defined by the Killip tag is specified in the Physical Findings section defined by the Physical Findings tag, the input of Killip is encouraged in the case of “myocardial infarction (target episode number 0002).” Also because the SBP section defined by the SBP tag is specified in the Vital Signed section defined by the Vital Signed tag, the input of SBP is encouraged in the case of “myocardial infarction (target episode number 0002).”

FIG. 24 shows an example of the data input screen 2041 through which the data provider inputs findings and the like. The data input screen includes patient ID, patient name, problem 2403, Subjective 2403, Objective 2404, Assessment 2407, and the like. Doctors and the like, which are the data providers, input findings and the like in accordance with this screen.

Next, a flow in which a data provider inputs data will be explained with reference to FIG. 22. A doctor starts inputting the patient ID, patient name, and the like in accordance with the findings input screen of FIG. 24. In Step 2201, the disease name is entered as an episode in the problem input area 2402 of FIG. 24. This input is sent from the computer of the data provider to the computer of the health care information service business operator 101 via network. In Step 2202, the computer of the service business operator 101 searches the storage 108 for a template for the episode (disease name) entered in Step 2201 in which input items were specified by the data consumer as described with FIG. 23, based on the episode information of the Problem tag 2301 of the template. This template is registered in the memory by the data consumer in advance, specifying items using the form shown in FIG. 23. If the template for the episode is found as a result of the search, the template is selected. In Step 2203, if the template for the specified episode was found in Step 2202, the process moves to the template display step 2204. If the template was not found, the process returns to Step 2201. After returning to Step 2201, it is regarded that there is no template for this episode, and continues inputting findings and the like in the doctor's own way. The search result is notified to the computer of the data provider along with the content of the template.

In Step 2204, after receiving the result, the computer of the data provider modifies the findings input screen 2401 based on the selected template. For example, in the case of the template shown in FIG. 23, the Killip tag 2304 exists in the Physical Findings tag 2303. In the Vital Signed tag 2305, the SBP tag 2306 exists. According to this information, in the findings input screen 2401 of FIG. 24, an area 2405 corresponding to the Killip tag 2304 and an area 2406 corresponding to the SBP tag 2306 appear in the Objective area 2404. On the other hand, because no detailed tag exists in the Subjective tag 2307 or the Assessment tag 2308, detailed information is not displayed in the Subjective area 2403 or Assessment area 2407 of the findings input screen 2401.

In Step 2205, data input is conducted based on the findings input screen 2401 displayed in Step 2204. After the data input is completed, the computer of the data provider sends the data, in which specified items of the template are filled, to the computer of the health care information service business operator via network.

In this way, the data such as findings specified by the data consumer through the input/output terminal is stored in the memory of the computer of the health care information service business operator.

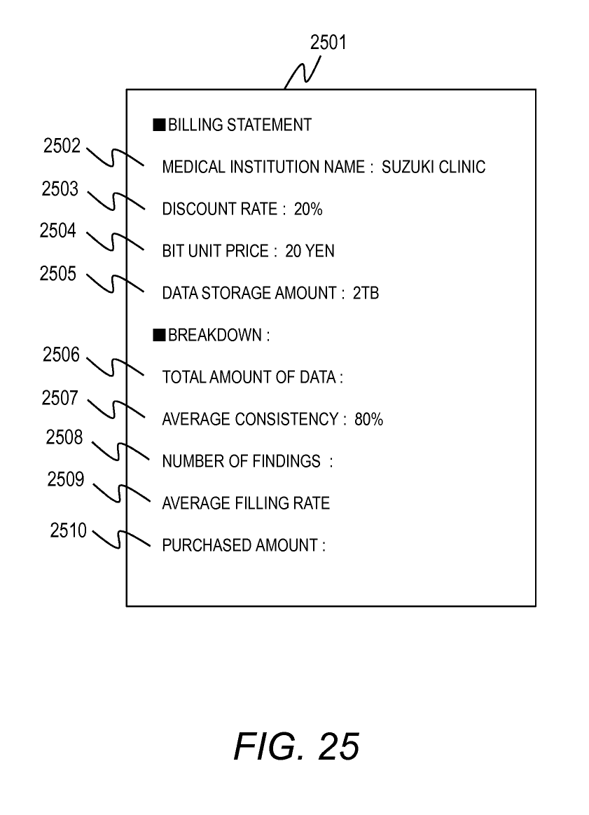

In Step 1814 of FIG. 18, an operation of issuing a billing information statement 2501 shown in FIG. 25 to each data provider is considered. This allows each data provider to understand the grounds of the discount rate. Specifically, the billing system 110 searches the billing information table 1901 of FIG. 19 for the discount rate 1903, the bit price unit 1904, the data storage amount 1905, the total amount of data 1906, the average consistency 1907, the number of findings 1908, and the average filling rate 1909 for each medical institution. The respective types of information are displayed under the discount rate 2503, the bit unit price 2504, the data storage amount 2505, the total amount of data. 2506, the average consistency 2507, the number of findings 2508, and the average filling rate 2509 of FIG. 25.

Also, the purchased amount 2004 is looked up in the purchased amount table 2001 of FIG. 20 for each medical institution. This information is displayed in the purchased amount 2510 of FIG. 25.

The billing statement of FIG. 25 may be provided as electronic data from the computer of the health care information service business operator, which collected the data in the manner described above, to the data provider via network, or may be provided as a paper statement printed out via an input/output device.

### Embodiment 2

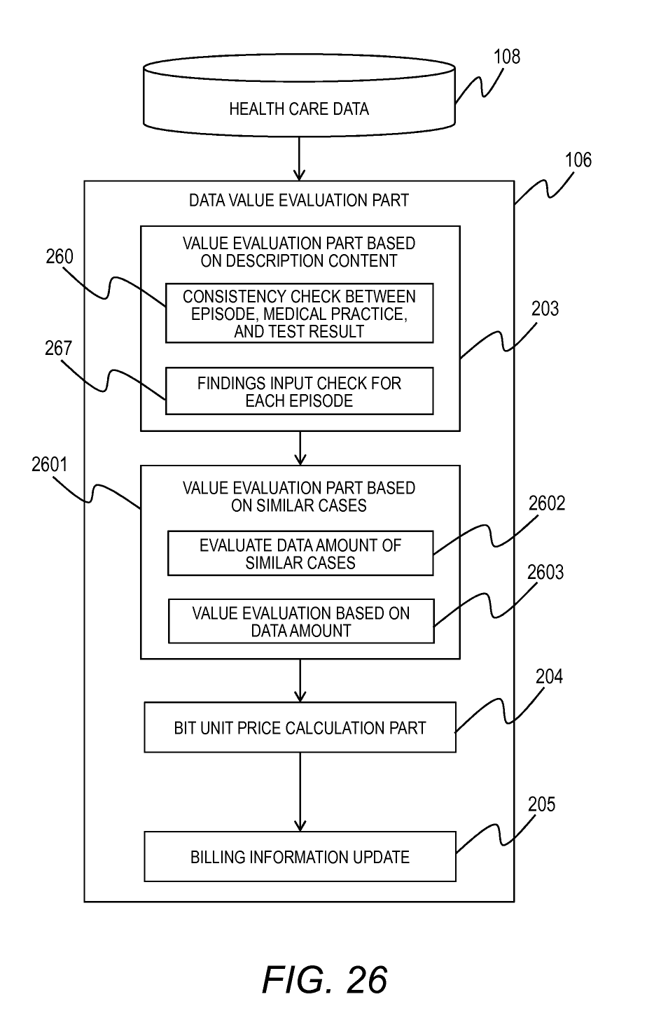

FIG. 26 shows the process flow of the data value evaluation part 106 of FIG. 1 with modifications. In the present embodiment (Embodiment 2), a value evaluation part 2601 based on similar cases is provided in addition to the value evaluation part based on the description content of Embodiment 1. The value evaluation part 2601 based on similar cases includes similar case data amount evaluation 2602 and value evaluation 2603 based on the data amount. In this example, the billing model in which a data provider that provides a greater number of similar cases requested by data consumers can receive a greater discount rate on the data storage fee will be explained.

Below, the configuration of the data handled by the system that realizes above-mentioned functions will be explained.

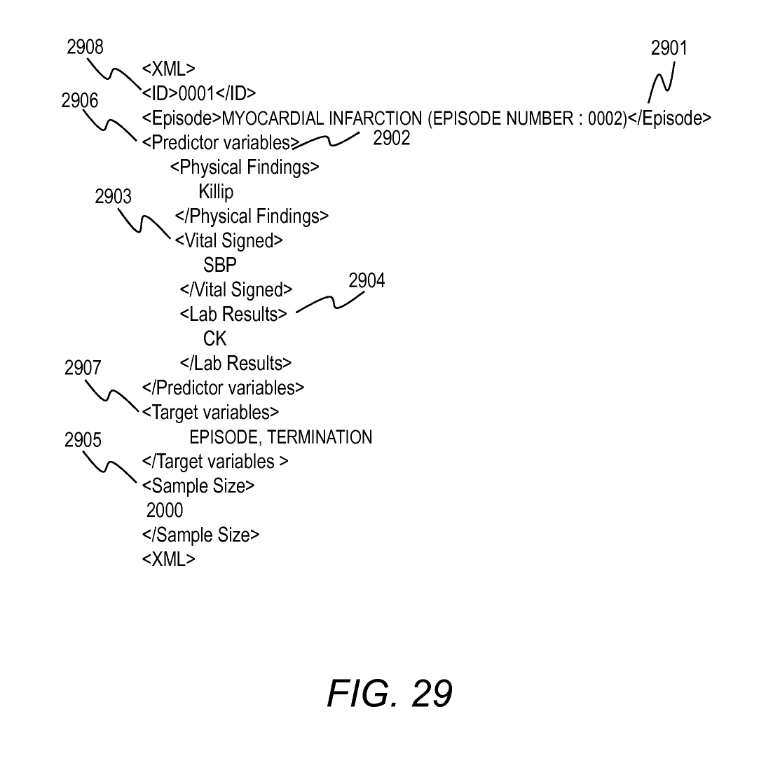

FIG. 29 is an XML file for the search criteria used to find similar cases requested by the data consumers, and a search template created by the data consumers. The data management part 105 stores in the memory the XML file received from a computer of the data consumer through network. This file includes ID tag 2908, Episode tag 2901, Predictor variables tag 2906, Physical Findings tag 2902, Vital Signed tag 2903, Lab Results tag 2904, Target variables tag 2907, and Sample Size tag 2905. In FIG. 29, “myocardial infarction (target episode number 0002)” is written in the Episode section defined by the Episode tag. Also, Killip is entered in the Physical Findings section defined by the Physical Findings tag, which means that in the case of “myocardial infarction (target episode number 0002),” the data consumers are looking to receive similar cases in which Killip is entered as the search criteria. Similarly, SBP is entered in the Vital Signed section defined by the Vital Signed tag, and CK is entered in the Lab Results section defined by the Lab Results tag, which means that in the case of “myocardial infarction (target episode number 0002),” the data consumers are looking to receive similar cases in which SBP and CK are entered as the search criteria. Lastly, 2000 is entered in the Sample Size section defined by the Sample Size tag, which means that, in the case of “myocardial infarction (target episode number 0002),” the data consumers are looking to receive at least 2000 similar cases that match the above-mentioned search criteria.

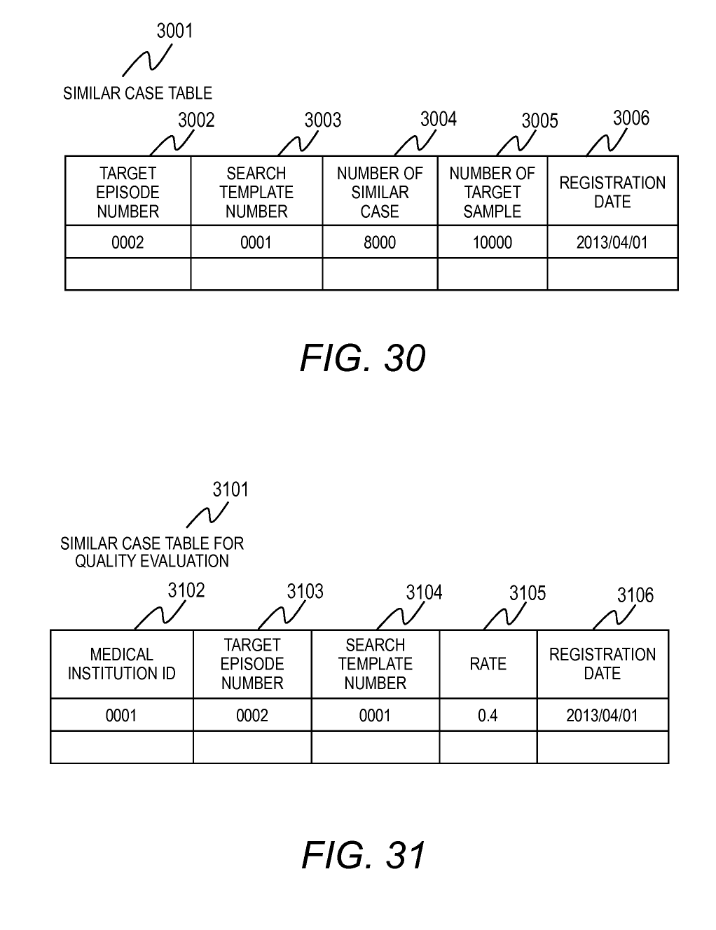

FIG. 30 shows a similar case table 3001. This table manages information relating to similar cases for each target episode, and includes target episode number 3002 that identifies a target episode, search template number 3003 that identifies a template relating to the search criteria for finding similar cases, number of similar case 3004 found in the search based on the template, number of target sample 3005 set by the data consumer for the similar cases, and registration date 3006 of the record. The data in this table except for the number of similar case is created by the data consumers, and the data management part stores, in the memory, the data received through network from the computer of the data consumers.

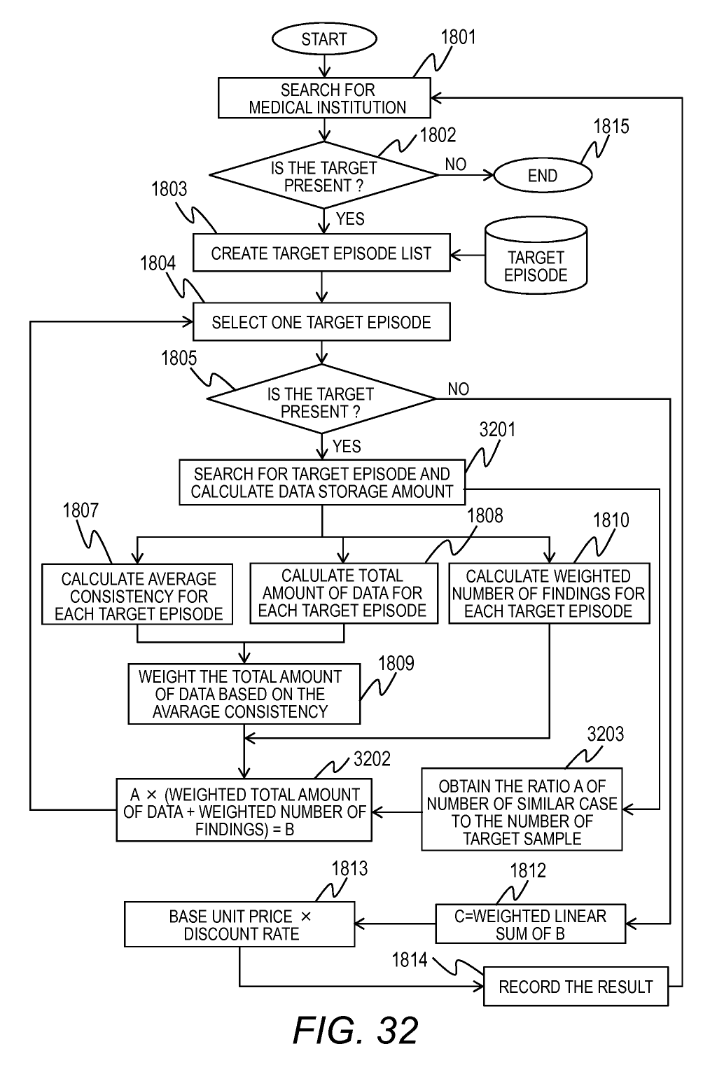

FIG. 31 shows a similar case table for quality evaluation 3101. This table manages information relating to similar cases for each medical institution, and includes medical institution ID 3102 that identifies a medical institution, target episode number 3103 that identifies a target episode, search template number 3104 that identifies a template relating to the search criteria for finding similar cases, ratio 3105 that indicates a ratio of the number of similar case found in the search based on the template of the search template number to the number of target sample, and registration date 3106 of the record. The data in this table is generated by the data value evaluation part 106 of the health care information service business operator in the process shown in FIG. 32.

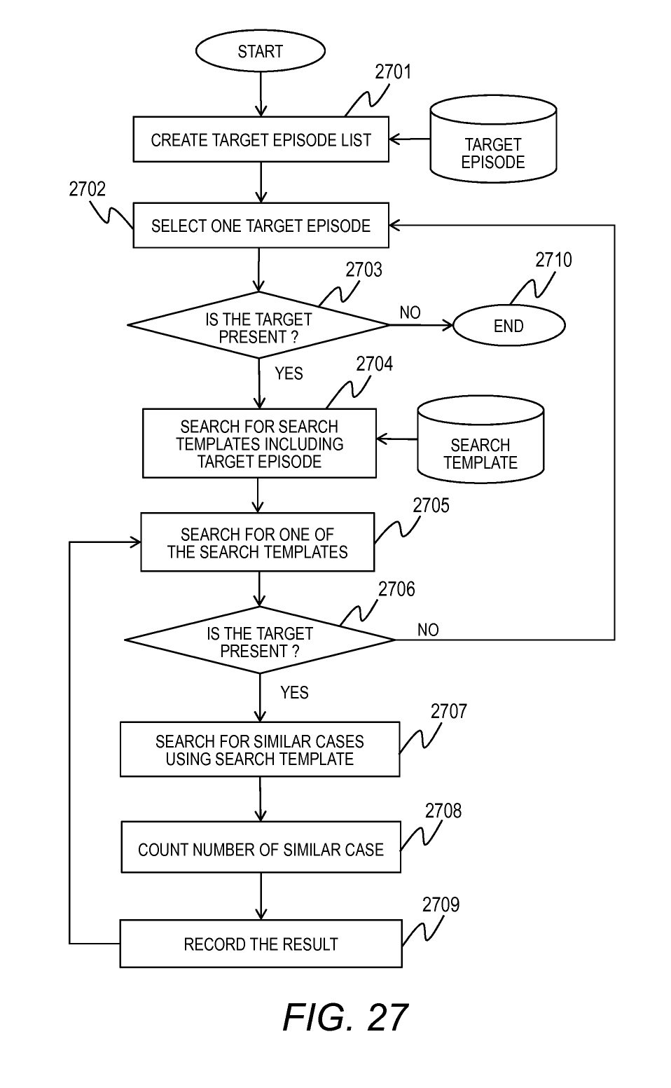

FIG. 27 shows a process flow of the value evaluation part 2601 based on similar cases of FIG. 26.

In Step 2701, a list of episodes to be processed is acquired from the target episode table 301 of FIG. 3. In Step 2702, one target episode is selected from the list. In Step 2703, if a target episode exists, the process moves to Step 2704, and if a target episode does not exist, the process is ended after proceeding to Step 2710.

In Step 2704, all search template files including the target episode are searched for. In Step 2705, one of the search template files is selected. In Step 2706, if a search template exists, the process moves to Step 2707. If a search template does not exist, the process returns to Step 2702.

In Step 2707, similar cases are searched for using the search template of Step 2705. The file structure of the search template is as described with reference to FIG. 29. The search process of Step 2707 is conducted by focusing on the description content of the Episode tag 2901. In the example of FIG. 29, myocardial infarction (target episode number 0002), Killip, SBP, and CK are entered in the Episode tag 2901, the Physical Findings tag 2902, the Vital Signed tag 2903, and Lab Results tag 2904. In the present embodiment, Killip and SBP of the findings and the laboratory test CK are the target of the search. Other medical practices such as prescription may also be the target for the search.

First, the case in which the laboratory test CK is the search target will be explained. Based on the target episode number selected in Step 2702, the target episode number 506 is looked up in the episode table 501 of FIG. 5, and the episode number 502 is acquired from the found records. Next, based on this episode number, the item 902 is looked up in the relational table 901 of FIG. 9. Because Lab Results is the results of a laboratory test, the records in which the table name 903 is medical practice are extracted, and the reference number 904 of those records is retrieved. Next, based on the reference number, the order number 602 is looked up in the medical practice table 601 of FIG. 6. Then records in which the practice name 603 is laboratory test are extracted, and the order number 602 of those records is retrieved. Based on this order number, the test result table 701 of FIG. 7 is searched for a record in which the test name 703 is CK. If such a record in which the test name is CK exists, the record found in Step 2707 is a candidate of the similar cases for the search template.

Next, the case in which Killip and SBP of the findings are the search target will be explained. First, all findings files in which the target episode number 0002 is entered in the Problem tag 1601 of FIG. 16. Among those findings files, the files in which the Killip tag exists in the Physical Findings tag 1603 and the SBP tag exists in the Vital Signed tag 1605 are candidates of similar cases for the search template.

In Step 2708, for the target episode selected in Step 2702, the number of similar case candidates extracted in Step 2705 is counted.

In Step 2709, the target episode number of the target episode selected in Step 2702, the search template number of the search template selected in Step 2705, the number of similar case counted in Step 2708, and the number of target sample written in the Sample Size tag 2905 of the search template are entered in the target episode number 3002, the search template number 3003, the number of similar case 3004, and the number of target sample 3005 in the similar case table 3001 of FIG. 30, respectively. When the results are recorded, the process returns to Step 2705, and the next search template is searched for.

As described above, by conducting the flow of FIG. 27, it is possible to find the candidates of similar cases for each target episode and each search template.

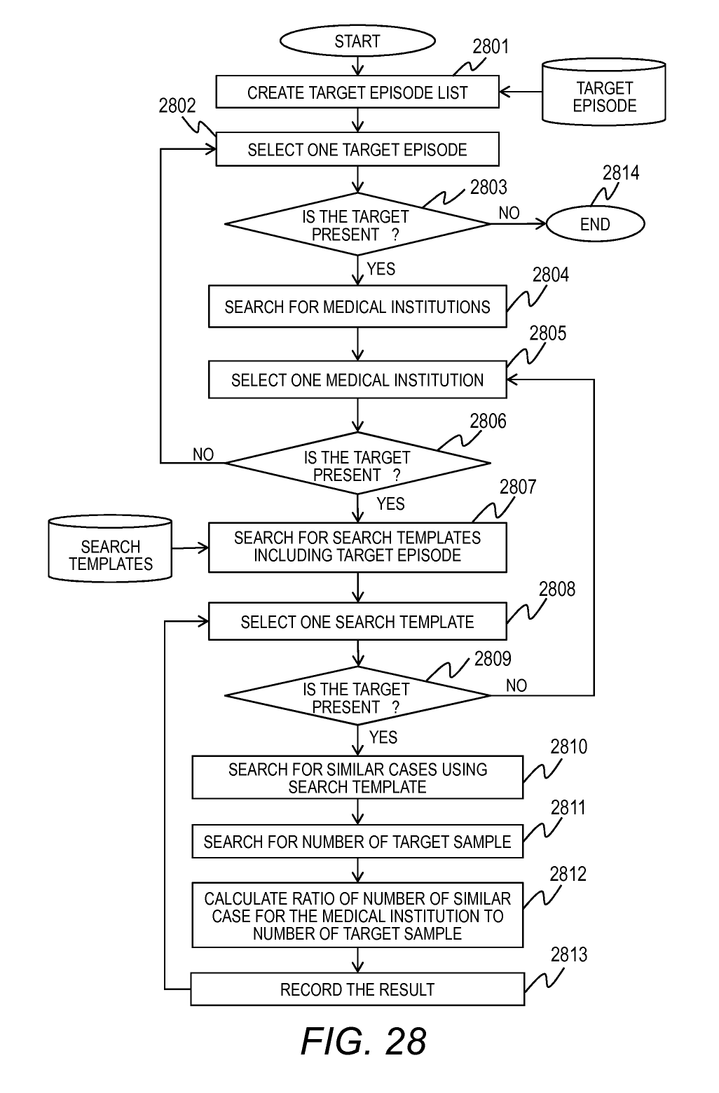

FIG. 28 shows a process flow of the value evaluation part 2603 based on the data amount.

In Step 2801, a list of episodes to be processed is acquired from the target episode table 301 of FIG. 3. In Step 2802, one target episode is selected from the list. In Step 2803, if a target episode exists, the process moves to Step 2804, and if a target episode does not exist, the process is ended after proceeding to Step 2814.

In Step 2804, all medical institutions are looked up in the medical institution table 1501 of FIG. 15.

In Step 2805, one of the medical institutions is selected. In Step 2806, if such a record exists, the process moves to Step 2807. If such a record does not exist, the process returns to Step 2802.

In Step 2807, all search template files including the target episode selected in Step 2802 are searched for. In Step 2808, one of the search template files is selected. In Step 2809, if a search template file exists, the process moves to Step 2810. If such a template does not exist, the process returns to Step 2805.

In Step 2810, based on the search template selected in Step 2808, similar cases for the medical institution selected in Step 2805 are searched for. First, patients who go to the medical institution selected in Step 2804 are selected from the patient table 401 of FIG. 4. Specifically, referring to the medical institution ID 403 of the patient table 401, a list of patients who went to the medical institution is created.

Below, the explanation will be made based on the search template of FIG. 29.

In Step 2810, based on the target episode number selected in Step 2802 and the patient IDs in the patient list described above, the target episode number 506 and the patient ID 503 are looked up in the episode table 501 of FIG. 5, and the episode number 502 is acquired from the found records.

Next, in Step 2810, this episode number is looked up in the item 902 of the relational table 901 of FIG. 9. Because Lab Results is the results of a laboratory test, records in which the table name 903 is medical practice are extracted, and the reference number 904 of those records is acquired. Next, based on the acquired reference number, the order number 602 is looked up in the medical practice table 601 of FIG. 6. Then records in which the practice name 603 is the laboratory test are extracted, and the order number 602 of those records is acquired. Based on this order number, the test result table 701 of FIG. 7 is examined, and records in which the test name 703 is CK are searched for. If such a record in which the test name is CK exists, the record found in Step 2802 is a candidate of the similar cases for the search template.

Also, in Step 2810, findings files in which the Problem tag 1601 of FIG. 16 (progress record file of clinical data) is the target episode number 0002 and the Patient ID tag 1608 is the patient ID described above are searched for. In those findings files, the Killip tag exists in the Physical Findings tag 1603, the SBP tag exists in the Vital Signed tag 1605, and both tags have entries, and therefore, the findings files are candidates of similar cases for the search template. Lastly, the quantity of the similar case candidates is counted, thereby obtaining the number of similar case.

In Step 2811, the number of target sample of the target episode selected in Step 2802 is acquired from the item 3005 of the similar case table of FIG. 30.

In Step 2812, a ratio of the number of similar case obtained in Step 2810 to the target sample quantity found in Step 2811 is calculated. If the ratio is 1 or greater, the ratio is rounded off to 1. The closer the ratio of the number of similar cases to the target sample number to 1, the closer the results are to the request from the data consumers.

In Step 2813, the medical institution ID of the medical institution is selected in Step 2805, the target episode number of the target episode selected in Step 2802, the search template number of the search template selected in Step 2808, and the ratio of the number of similar case to the number of target sample calculated in Step 2812 are entered in the medical institution ID 3102, the target episode number 3103, the search template number 3104, and the ratio 3105 of the quality evaluation similar case table 3101 of FIG. 31, respectively. The registration date 3106 is also recorded. After Step 2813, the process returns to Step 2808, and the same processes are conducted on the next search template.

As described above with reference to FIG. 28, the quality evaluation similar case table 3101 is filled out for the target episode, medical institution, and search template.

Next, the bit unit price calculation part 2604 of FIG. 26 will be explained with reference to FIG. 32. The flow of FIG. 32 is the same as the flow of FIG. 18 except for Step 3201, Step 3202, and Step 3203, and only those steps will be explained. Step 3201 also has a branching flow to Step 3202 in addition to Step 1806, Step 1808, and Step 1810 of FIG. 18. In Step 3203, for the target episode selected in Step 1804, the ratio 3105 is acquired from the quality evaluation similar case table 3101 of FIG. 31. In Step 3202, a product of the sum of the weighted total number of data and the weighted findings quantity and the ratio acquired from Step 3203 is calculated, and the resultant value is set to a value “B” of Step 1811 of FIG. 18. The subsequent steps are the same as the processes in FIG. 18. From the perspective of the value evaluation of data, the closer it is to the number of target sample requested by the data consumers, the greater the roll of the weighted total number of data +weighted findings quantity is. That is, by Step 3202 and Step 3203 of FIG. 32, the ratio of the number of target sample is reflected in the data storage fee of health care information.

As described above, it is possible to provide a system in which a medical institution such as a hospital that has accumulated useful data that allows for secondary usage can receive a greater discount on the data storage fee depending on the quality of the data. This acts as an incentive for the medical institution, and as a result, the collection of high-quality clinical data appropriate for secondary usage is promoted. The core of this system is the evaluation on data based on the quality and filling rate of the description content, and based on the evaluation result, the discount rate on the storage fee is calculated. The evaluation based on the quality and filling rate of the description content is conducted on each episode such as a disease name, and the consistency between the episode and the medical practice such as prescription or laboratory test and the test results is checked based on the diagnosis medical knowledge that specifies the relationship therebetween. The more data having a higher degree of consistency is, the higher the quality is. In addition, the filling rate of the free text data template input area in the findings input is evaluated, and the greater the filling rate is, the higher the quality is. It is also possible to add a process to increase the discount rate in proportion to the data purchased amount of the data consumers. It is also possible to add an operation allowing the data consumers to specify the input items, and the input items are displayed in the data input screen of the medical institutions so as to improve the quality and filling rate of the findings input. Furthermore, it is possible to add an operation to present the evaluation results of the quality and filling rate, the discount rate, and the data purchased amount to the medical institutions.

In other words, the system described above provides the function of rewarding the efforts to improve the quality and filling rate of the data for the secondary usage of the data such as clinical researches and the like in the form of the discount on the storage fee, and therefore, it is possible to justify the efforts of the data providers in the form of monetary compensation. With the function of this system, an improvement in the quality and filling rate of the data provided by the data providers is expected, and as a result, the data consumers can obtain data set required for the secondary usage of the data with ease. Furthermore, the function of this system allows the health care service business operator to expect an improvement in quality and filling rate of the accumulated data, which makes it possible to attract more data consumers.

1. A health care information processing system that accumulates health care information, comprising:
a receiving part that receives the health care information from a computer of a data provider;
a memory part that stores therein criteria relating to health care and medical treatment with which the health care information is evaluated;
an evaluation part that evaluates a value of the health care information based on the received health care information and the criteria; and
a billing part that determines a fee for accumulating the health care information based on the value.

2. The health care information processing system according to claim 1,
wherein the criteria include a plurality of items, and
wherein the evaluation part evaluates the value based on a plurality of items included in the health care information and consistency between the criteria and said plurality of items.

3. The health care information processing system according to claim 2,
wherein the evaluation part evaluates the value based on a filling rate of a free text data template input area in the health care information.

4. The health care information processing system according to claim 3,
wherein the billing part weights a data amount of the accumulated health care information based on the consistency and the filling rate, and determines the fee based on a ratio of the weighted data amount to an amount of data stored.

5. The health care information processing system according to claim 4,
wherein the billing part determines the fee based on the filling rate when the filling rate is equal to or greater than a prepared numerical value stored in the memory.

6. The health care information processing system according to claim
wherein the billing part determines the fee based on an amount of the accumulated health care information in the system purchased by a data consumer.

7. The health care information processing system according to claim 1,
wherein the receiving part receives, from the computer of the data consumer that uses the health care information, template input information that specifies input content of a free text data template input area in the health care information, and
wherein the health care information processing system further comprises a sending part that sends out the template input information such that the template input information is displayed in a data input screen of a computer of the data provider.

8. The health care information processing system according to claim 6,
wherein the data amount of health care information stored in the health care information processing system, the data purchased amount, and the fee are notified to the data provider.

9. The health care information processing system according to claim 3,
wherein the evaluation part calculates, based on a storage data amount of the health care information that matches data items requested by a data consumer and a number of target sample for the data items, a ratio of said storage data amount to the number of target sample, and evaluates a value of the health care information based on said ratio.

10. The health care information processing system according to claim 9,
wherein the billing part weights a data amount of the accumulated health care information based on the consistency and the filling rate, and determines the fee based on a ratio of the weighted data amount to a data storage amount and the ratio of the data storage amount to the number of target sample.

11. The health care information processing system according to claim 9,
wherein the billing part determines the fee based on an amount of data purchased by a data consumer among the accumulated health care information in the health care information processing system.

12. The health care information processing system according to claim 9,
wherein the receiving part receives, from the computer of the data consumer that uses the health care information, template input information that specifies input content of a free text data template input area in the health care information, and
wherein the health care information processing system further comprises a sending part that sends out the template input information such that the template input information is displayed in a data input screen of a computer of the data provider.

13. The health care information processing system according to claim 9,
wherein the data amount of health care information stored in the health care information processing system, the data purchased amount, and the fee are notified to the data provider.

14. A health care information processing system that accumulates health care information, comprising:
a receiving part that receives the health care information from a computer of a data provider;
a memory part that stores therein criteria relating to health care and medical treatment with which the health care information is evaluated; and
a billing part that determines a fee for accumulating the health care information based on the received health care information and the criteria.

15. A rate calculation method conducted by a health care information processing system that stores therein health care information, comprising:
receiving the health care information from a computer of a data provider via communication network;
storing, in a memory part, criteria relating to health care and medical treatment for evaluating the health care information; and
determining a fee for storing the health care information based on the received health care information and the stored criteria.
